(19) United States
(12) Patent Application Publication
(10) Pub. No.: US 2023/0377335 A1
(43) Pub. Date: Nov. 23, 2023

(54) KEY PERSON RECOGNITION IN IMMERSIVE VIDEO

(71) Applicant: Intel Corporation, Santa Clara, CA (US)

(72) Inventors: Liwei LIAO, Beijing (CN); Ming LU, Beijing (CN); Haihua LIN, Beijing (CN); Xiaofeng TONG, Beijing (CN); Wenlong LI, Beijing (CN)

(73) Assignee: Intel Corporation, Santa Clara, CA (US)

(21) Appl. No.: 18/030,452

(22) PCT Filed: Nov. 10, 2020
(86) PCT No.: PCT/CN2020/127754

§ 371 Date: Apr. 5, 2023

(51) Int. Cl. G06V 20/40; G06V 10/82; G06T 7/73

(52) U.S. Cl. CPC G06V 20/42; G06V 20/46; G06V 10/82; G06T 7/73; G06T 2207/10016; G06T 2207/30196; G06T 2207/30242; G06T 2207/20084; G06T 2207/30224

(57) ABSTRACT

Techniques related to key person recognition in multi-camera immersive video attained for a scene are discussed. Such techniques include detecting predefined person formations in the scene based on an arrangement of the persons in the scene, generating a feature vector for each person in the detected formation, and applying a classifier to the feature vectors to indicate one or more key persons in the scene.

### BACKGROUND

In immersive video and other contexts such as computer vision applications, a number of cameras are installed around a scene of interest. For example, cameras may be installed in a stadium around a playing field to capture a sporting event. Using video attained from the cameras, a point cloud volumetric model representative of the scene is generated. A photo realistic view from a virtual view within the scene may then be generated using a view of the volumetric model which is painted with captured texture. Such views may be generated in every moment to provide an immersive experience for a user. Furthermore, the virtual view can be navigated in the 3D space to provide a multiple degree of freedom immersive user experience.

In such contexts, particularly for sporting scenes, the viewer has a strong interest in observing a key person or persons in the scene. For example, for team sports, fans have an interest in the star or key players. Typically, both basketball (e.g., NBA) and American football (e.g., NFL) have dedicated manually operated cameras to follow the star players to capture their video footage for fan engagement. However, such manual approaches are expensive and not scalable.

It is desirable to detect key persons(s) in immersive video such that the key person may be tracked, a view may be generated for the person, and so on. It is with respect to these and other considerations that the present improvements have been needed. Such improvements may become critical as the desire to provide new and immersive user experiences in video becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 illustrates an example system for performing key person detection in immersive video multi-camera systems;

FIG. 2 illustrates an example camera array trained on an example 3D scene;

FIG. 3 illustrates example person and object detection and recognition in multi-camera immersive video;

FIG. 4 illustrates a top down view of an example formation for detection and a camera view presented by a video picture of another example formation;

FIG. 5 illustrates top down views of exemplary formations of players in arrangements that are common during a sporting event;

FIG. 6 illustrates top down views of team separation detection operations applied to exemplary formations;

FIG. 7 illustrates top down views of line of scrimmage verification operations applied to exemplary formations;

FIG. 8 illustrates an example graph-like data structure generated based on person data as represented by an formation via an adjacent matrix generation operation;

FIG. 9 illustrates top down views of example formations for key person detection;

FIG. 10 illustrates an example table of allowed number ranges for positions in American football;

FIG. 11 illustrates an example a graph attentional network employing a number of graph attentional layers to generate classification data based on an adjacent matrix and feature vectors;

FIG. 12 illustrates an example generation of an activation term in a graph attentional layer;

FIG. 13 illustrates an example key person tracking frame from key persons detected using predefined formation detection and graph based key person;

FIG. 14 is a flow diagram illustrating an example process for identifying key persons in immersive video;

FIG. 15 is an illustrative diagram of an example system for identifying key persons in immersive video;

FIG. 16 is an illustrative diagram of an example system; and

FIG. 17 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

Methods, devices, apparatuses, computing platforms, and articles are described herein related to key person detection in immersive video contexts.

As described above, it is desirable to detect key persons such as star or key players in sporting contexts such that the detected person can be tracked, a virtual view of the person can be generated, and for other purposes. Herein, such key person detection is presented in the context of sporting events and, in particular, in the context of American football (e.g., NFL) for the sake of clarity of presentation. However, the discussed techniques may be applied, as applicable, in any context, sporting or otherwise.

In some embodiments, a number of persons are detected in video pictures of any number of video sequences contemporaneously attained by cameras trained on a scene. The term contemporaneous indicates the pictures of video are captured for the same time instance and frames having the same time instance may be simultaneous to any level of precision. Although discussed with respect to person detection being performed for one picture of a particular sequence, such detection may be performed using any number of pictures across the sequences (i.e., using different views of the scene), by tracking persons across time instances (i.e., temporal tracking), and other techniques. Based on the detected persons, a determination is made as to whether a predefined person formation is detected in a video picture. As used herein, the terms predefined formation, predefined person formation, etc. indicate the persons are in a formation having characteristics that meet certain criteria. Notably, the persons may be in any range of available formations and the techniques discussed herein detect predefined formations that are of interest. Such formation detection may be performed using any suitable technique or techniques. In some embodiments, a desired predefined person formation is detected when two teams (or subgroups) of persons are spatially separated in the scene (as based on detected person locations in the 3D space of the scene) and arranged according to predefined conditions.

In an embodiment, the spatial separation is detected by identifying a person of a first team (or subgroup) that is a maximum distance along an axis applied to the scene among the persons of the first team (or subgroup) and another person of a second team (or subgroup) that is a minimum distance along the axis among the persons of the second team (or subgroup). When the second person is a greater distance along the axis than the first person, spatial separation of the first and second teams (or subgroups) is detected and, otherwise no spatial separation is detected. Such techniques provide spatial separation of the two teams (or subgroups) only when all persons of the first team (or subgroup) are spatially separated along the axis from all persons of the second team (or subgroup). That is, even one overlap of persons along the axis provides for no detected spatial separation. Such techniques advantageously limit false positives where the two teams (or subgroups) have begun to move to a formation for which detection is desired but have not yet fully arrived at the formation. Such techniques are particularly applicable to American football where, after a play, the two teams separate and eventually move to a formation for the start of a next play. Notably, detection is desirable when the teams are in the formation to start the next play but not prior.

In addition, the desired formation is only detected when a number of persons from the first and second subgroups (or teams) that are within a threshold distance of a line dividing the first and second subgroups (or teams), such that the line is orthogonal to the axis used to determine separation of the first and second subgroups (or teams) exceeds another threshold. For example, the number of persons within the threshold distance of the line, as determined in the 3D space of the scene, are determined such that the threshold may be about 0.5 meters or less (e.g., about 0.25 meters). The number of persons within the threshold distance of the line is then compared to a threshold such as a threshold of 10, 11, 12, 13, or 14 persons. If the number of persons within the threshold distance of the line exceeds the threshold number of persons (or meets the threshold number of persons in some applications), the desired formation is detected and, otherwise, the desired formation is not detected (even if spatial separation is detected) and processing continues at a next video picture. Such techniques are again particularly applicable to American football where, at the start of a play, the two teams set in a formation on either side of a line of scrimmage (e.g., the line orthogonal to the axis) such that they are separated (as discussed above) and in a formation with each team having a number of players within a threshold distance of the line of scrimmage. Such formation detection thereby detects a start of a next play in the game.

When a desired formation is detected, a feature vector is determined for each (or at least some) of the persons (or players) in the detected formation. The feature vector for each person may include any suitable features such as a location of the person (or player) in 3D space, a subgroup (or team) of the person (or player), a person (or player) identification of the person (or player) such as a uniform number, a velocity of the person (or player), an acceleration of the person (or player), and a sporting object location within the scene for a sporting object corresponding to the sporting event. As used herein, the term sporting object indicates an object used in the sporting event such as a football, a soccer ball, a basketball, or, more generally, a ball, a hockey puck, disc, and so on.

A classifier such as a graph attention network is then applied to the feature vectors representative of the persons (or players) to indicate one or more key persons of the persons (or players). For example, each of the persons (or players) may be represented as a node for application of the graph attention network and each node may have characteristics defined by the feature vectors. For application of the graph attention network, an adjacent matrix is generated to define connections between the nodes. As used herein, the term adjacent matrix indicates a matrix that indicates nodes that have connections (e.g., adjacent matrix values of 1) and those that are not connected (e.g., adjacent matrix values of 0). Whether or not connections exist or are defined between the nodes may be determined using any suitable technique or techniques. In some embodiments, when the difference in the locations in 3D space of two nodes (e.g., the distance between the persons (or players)) is less than or equal to a threshold such as 2 meters a connection is provided and when the distance exceeds the threshold, no connection is provided.

The feature vectors for each node and the adjacent matrix are then provided to the pre-trained graph attention network to generate indicators indicative of key persons of the persons in the formation. The graph attention network may be pretrained using any suitable technique or techniques such as pretraining using example person formations (e.g., that meet the criteria discussed above) and ground truth key person data. The indicators of key persons may include any suitable data structure. In some embodiments, the indicators provide a likelihood value of the person being a key person (e.g., from 0 to 1 inclusive). In some embodiments, the indicators provide a most likely position of the person, which is translated to key persons. For example, in the context of American football, the indicators may provide a person that is most likely to be quarterback, person(s) likely to be a running back, person(s) likely to be a defensive back, and so on and the positions may be translated to key persons such as those most likely to be near the ball when in play. Such indicators may be used in any subsequent processing such as person tracking (e.g., to track key persons), object tracking (e.g., to track where a ball is likely to go), virtual view generation (e.g., to generate a virtual view of key persons), and so on.

As discussed, American football is used for exemplary purposes to describe the present techniques. However, such techniques are applicable to other sports such as rugby, soccer, handball, and so on and to other events such as plays, political rallies, and so on. In American football, key players that are desired to be detected include the quarterback (QB), running back(s) (RB), wide receiver(s) (WR), corner back(s) (CB), and safety(ies) although others may be detected. Other sports and events have key persons particular to those sports and events. The techniques discussed herein automatically detect such key persons. For example, in the context of American football, the ball is in the hands of a key player in over 95% of the time. Therefore, the discussed techniques may be advantageously used to track key persons or players using virtual views or cameras as desired by viewers, showing a perspective from that of such key persons to provide an immersive experience for viewers, using the key persons to detect play direction or object tracking such that virtual views or camera placement and rotation can be more compelling to a viewer.

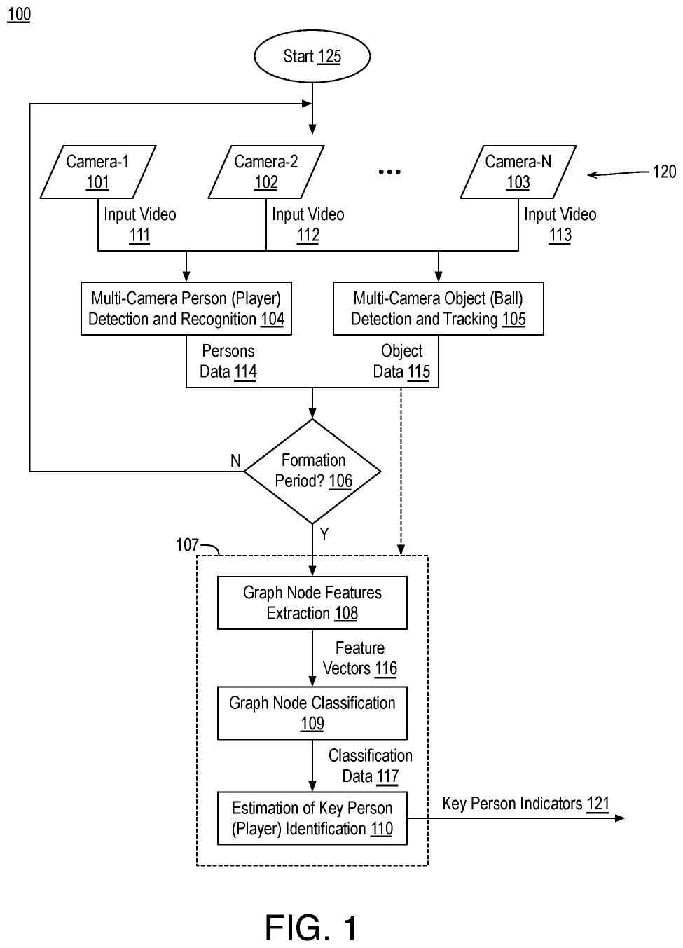

FIG. 1 illustrates an example system 100 for performing key person detection in immersive video multi-camera systems, arranged in accordance with at least some implementations of the present disclosure. System 100 may be implemented across any number of discrete devices in any suitable manner. In some embodiments, system 100 includes numerous cameras of a camera array 120 which are pre-installed in a stadium, arena, event location, etc., the same number of sub-servers or other compute resources to process the pictures or frames captured by the cameras of a camera array 120, and a main server or other compute resource to process the results of the sub-servers. In some embodiments, the sub-servers are employed as cloud resources.

In some embodiments, system 100 employs camera array 120 including individual cameras including camera 101, camera 102, camera 103, and so on, a multi-camera person (e.g., player) detection and recognition module 104, a multi-camera object (e.g., ball) detection and recognition module 105, a formation detection module 106, and a key persons detection module 107, which may include a graph node features extraction module 108, a graph node classification module 109, and an estimation of key person (e.g., player) identification module 110. System 100 may be implemented in any number of suitable form factor devices including one or more of a sub-server, a server, a server computer, a cloud computing environment, a personal computer, a laptop computer, a tablet, a phablet, a smart phone, a gaming console, a wearable device, a display device, an all-in-one device, a two-in-one device, or the like. Notably, in some embodiments, camera array 120 may be implemented separately from device(s) implementing the remaining components of system 100. System 100 may begin operation based on a start signal or command 125 to being video capture and processing. Input video 111, 112, 113 captured via cameras 101, 102, 103 of camera array 120 includes contemporaneously or simultaneously attained or captured pictures of a scene. As used herein, the term contemporaneously or simultaneously captured video pictures indicates video pictures that are synchronized to be captured at the same or nearly the same time instance within a tolerance such as 300 ms. In some embodiments, the captured video pictures are captured as synchronized captured video. For example, the components of system 100 may be incorporated into any multi-camera multi-processor system to deliver immersive visual experiences for viewers of a scene.

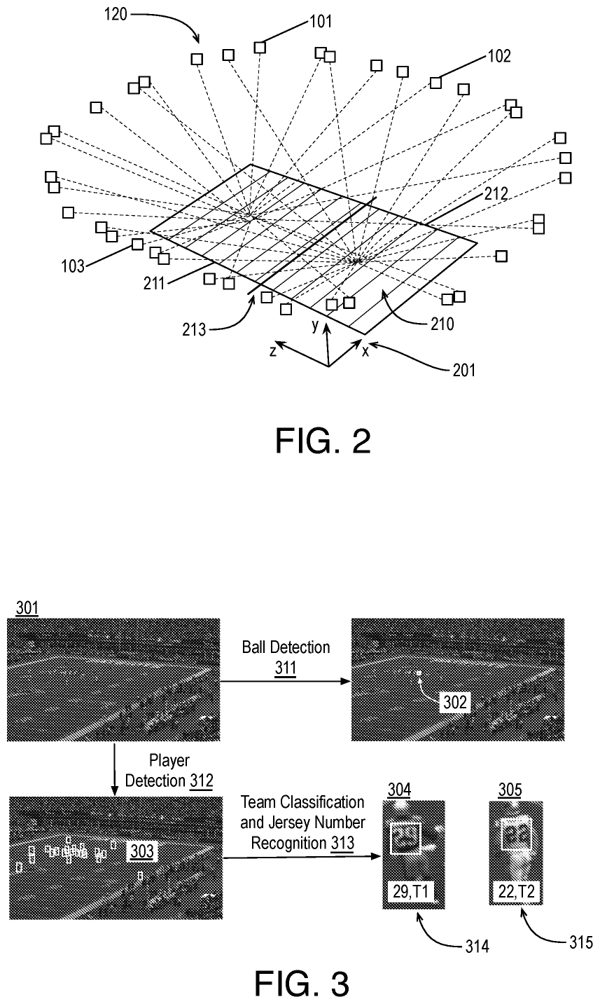

FIG. 2 illustrates an example camera array 120 trained on an example 3D scene 210, arranged in accordance with at least some implementations of the present disclosure. In the illustrated embodiment, camera array 120 includes 38 cameras (including cameras 101, 102, 103) trained on a sporting field. However, camera array 120 may include any suitable number of cameras trained on scene 210 such as not less than 20 cameras. For example, camera array 120 may be trained on scene 210 to capture video pictures for the eventual generation of a 3D model of scene 210 and fewer cameras may not provide adequate information to generate the 3D model. Furthermore, scene 210 may be any suitable scene such as a sport field, a sport court, a stage, an arena floor, etc. Camera array 120 may be mounted to a stadium (not shown) or other structure surrounding scene 210 and along the ground surrounding scene 210, calibrated, and trained on scene 210 to capture images or video. As shown, each camera of camera array 120 has a particular view of scene 210. For example, camera 101 has a first view of scene 210, camera 102 has a second view of scene 210, camera 103 has a third view of scene 210, and so on. As used herein, the term view indicates the image content of an image plane of a particular camera of camera array 120 or image content of any view from a virtual camera located within scene 210. Notably, the view may be a captured view (e.g., a view attained using image capture at a camera) such that multiple views include representations of the same person, object, entity, etc. Furthermore, each camera of camera array 120 has an image plane that corresponds to the image taken of scene 210.

Also as shown, a 3D coordinate system 201 is applied to scene 210. 3D coordinate system 201 may have an origin at any location and may have any suitable scale. Although illustrated with respect to a 3D Cartesian coordinate system, any 3D coordinate system may be used. Notably, it is the objective of system 100 to identify key persons within scene 210 using video sequences attained by the cameras of camera array 120. As discussed further herein, an axis such as the z-axis of 3D coordinate system 201 is defined, in some contexts, along or parallel to one of sidelines 211, 212 such that separation of persons (or players) detected in scene 210 is detected, at least in part, based on full separation of subgroups (or teams) of the persons along the defined axis. Furthermore, predefined formation detection, in addition to using such separation detection may be performed, at least in part, based on the arrangement of persons with respect to a line of scrimmage 213 orthogonal to the z-axis sidelines 211, 212 (and parallel to the x-axis) such that, when a number of persons (or players) within a threshold distance of line of scrimmage 213 exceeds a threshold number of persons, the desired formation is detected. In response to such predefined formation detection, a classifier is used, based on feature vectors associated with the persons in the person formation to identify the key person(s).

With reference to FIG. 1, each camera 101, 102, 103 of camera array 120 attains input video 111, 112, 113 (e.g., input video sequences including sequences of input pictures). Camera array 120 attains input video 111, 112, 113 each corresponding to a particular camera of camera array 120 to provide multiple views of scene 210. Input video 111, 112, 113 may include input video in any format and at any resolution. In some embodiments, input video 111, 112, 113 comprises 3-color channel video with each video picture having 3-color channels (e.g., RGB, YUV, YCbCr, etc.). Input video 111, 112, 113 is typically high resolution video such as 5120×3072 resolution. In some embodiments, input video 111, 112, 113 has a horizontal resolution of not less than 4000 pixels such that input video 111, 112, 113 is 4K or higher resolution video. As discussed, camera array 120 may include, for example 38 cameras. It is noted that the following techniques may be performed using all such cameras or a subset of the cameras. Herein the term video picture and video frame are used interchangeably. As discussed, the input to system 100 is streaming video data (i.e., real-time video data) at a particular frame rate such as 30 fps. The output of system 100 includes one or more indicators of key persons in a scene. In the following, the terms person or player, subgroup and team, and similar terms are used interchangeably without loss of generalization.

As shown, input video 111, 112, 113 is provided to multi-camera person detection and recognition module 104 and multi-camera object detection and recognition module 105. Multi-camera person detection and recognition module 104 generates person (or player) data 114 using any suitable technique or techniques such as person detection techniques, person tracking techniques, and so on. Person data 114 includes any data relevant to each detected person based on the context of the scene and event under evaluation. In some embodiments, person data 114 includes a 3D location (coordinates) of each person in scene 210 with respect to 3D coordinate system 201 (please refer to FIG. 2). For example, for each person, an (x, y, z) location is provided. In some embodiments, person data 114 includes a team identification of each person (e.g., a team of each player) such as an indicator of team 1 or team 2, home team or away team, etc. Although discussed with respect to teams, any subgrouping of persons may be applied and such data may be characterized as subgroup identification (i.e., each person may be identified as a member of subgroup 1 or subgroup 2). In some embodiments, person data 114 includes a unique identifier for each person (e.g., a player identifier) in the subgroup such as a jersey number. In some embodiments, person data 114 includes a velocity of each person such as a motion vector of each person with respect to 3D coordinate system 201. In some embodiments, person data 114 includes an acceleration of each person such as an acceleration vector of each person with respect to 3D coordinate system 201. Other person data 114 may be employed.

Multi-camera object detection and recognition module 105 generates sporting object (or ball) data 115 using any suitable technique or techniques such as object detection and tracking techniques, small object detection and tracking techniques, and so on. Object data 115 includes any data relevant to the detected sporting object based on the context of the scene and event under evaluation. In some embodiments, object data 115 includes a 3D location (coordinates) of the detected object with respect to 3D coordinate system 201. In some embodiments, object data 115 includes a velocity of the detected object such as a motion vector of each person with respect to 3D coordinate system 201. In some embodiments, object data 115 includes an acceleration of the detected object such as an acceleration vector of each person with respect to 3D coordinate system 201.

FIG. 3 illustrates example person and object detection and recognition in multi-camera immersive video, arranged in accordance with at least some implementations of the present disclosure. As shown, a video picture 301 is received for processing such that a video picture 301 includes a number of persons and a sporting object. Although illustrated with respect to a single video picture 301, the discussed techniques may be performed and merged using any number of video pictures from the same time instance and any number of temporally prior video pictures from the same or other views of the scene.

As shown, in a first processing pathway as illustrated with respect to ball detection operations 311, video picture 301 (and other video pictures as discussed) are processed to detect and locate a sporting object 302 in video picture 301 and the scene being captured by video picture 301. As discussed such techniques may include any suitable multi-camera object or ball detection, recognition, and tracking techniques. Furthermore, object data 115 corresponding to sporting object 302 as discussed with respect to FIG. 1 are generated using such techniques.

In a second processing pathway as illustrated with respect to player detection operations 312 and team classification and jersey number recognition operations 313, video picture 301 (and other video pictures as discussed) are processed to detect and locate a number of persons 303 (including players and referees in the context of video picture 301) in video picture 301 and the scene being captured by video picture 301. Furthermore, for all or some of the detected persons 303, a team classification and jersey number are identified as shown with respect to persons 304, 305. In the illustrated example, person 304 is a member of team 1 (T1) and has a jersey number of 29 and person 305 is a member of team 2 (T2) and has a jersey number of 22 as provided by person data 314, 315, respectively. For example, person data 314, 315 may make up a portion of person data 114. Such player detection and team classification and jersey number recognition may include any suitable multi-camera person or player detection, recognition, team or subgroup classification, jersey number or person identification techniques and they may generate any person data discussed herein such as any components of person data 114. Such techniques may include application of pretrained classifiers relevant to the particular event being captured. As discussed, person data 115 corresponding to persons 303 are generated using such techniques.

Returning to FIG. 1, after such information collection, processing continues with a predefined formation period detection or judgment as provided by formation detection module 106. Such techniques may be performed for each video picture time instance or at regular intervals (e.g., every 3 time instances, every 5 time instances, every 10 time instances, etc.) to monitor for detection of a particular desired formation. Notably, when such a predefined formation is detected, it is desirable to determine key persons at that time (and/or immediately subsequent to that time) as such key persons can change during an overall sporting event and be redefined at such time instances (e.g., as players are substituted in and out of games, as the offensive and defensive teams alternate, and so on). Therefore, real-time key person detection is advantageous in the context of various events. As shown, if the desired formation (or one of several evaluated formations) are not detected, system 100 continues with the above discussed information collection processing to update and to persons data 114 and object data 115 for a subsequent application of formation detection module 106. When a desired formation is detected, system 100 continues with processing as discussed below with respect to key persons detection module 107. Therefore, such processing may be bypassed (and computational resources saved) when no desired predefined formation is detected.

Formation detection module 106 attempts to detect a desired formation such that the formation prompts detection of key persons. Such a desired formation may include any suitable formation based on the context of the event under evaluation. Several sporting events include a similar formation for detection where active play has stopped and is about to restart. Such contexts include time between plays in American football (as illustrated and discussed herein), after goals and prior to the restart of play in hockey, soccer, rugby, handball, and other sports, at the start of such games or at the restart of such games after rest breaks, scheduled breaks, penalties, time-outs and so on. The formation detection techniques discussed herein may be applied in any such context and are illustrated and discussed with respect to American football without loss of generality.

For example, in American football, a formation period or time instance may be defined as a time just prior to initiation of a play (e.g., when the ball is snapped or kicked off). Formation detection module 106 determines whether a particular time instance is a predefined formation time instance (e.g., a start or restart formation). Typically, such a start or restart formation period is a duration when all or most players are set in a static position, which is prior to the beginning of a play. Furthermore, different specific formations for a detected formation time instance are representative of different offensive and defensive tactics. Therefore, it is advantageous to detect a predefined formation time instance because key player(s) in the formation at the detected formation time instance are in a relatively specific position, which may be leveraged by a classifier (e.g., a graph neural network, GNN) model to detect or find key players. As discussed, formation time instances exist in many sports such as American football, hockey, soccer, rugby, handball, and others.

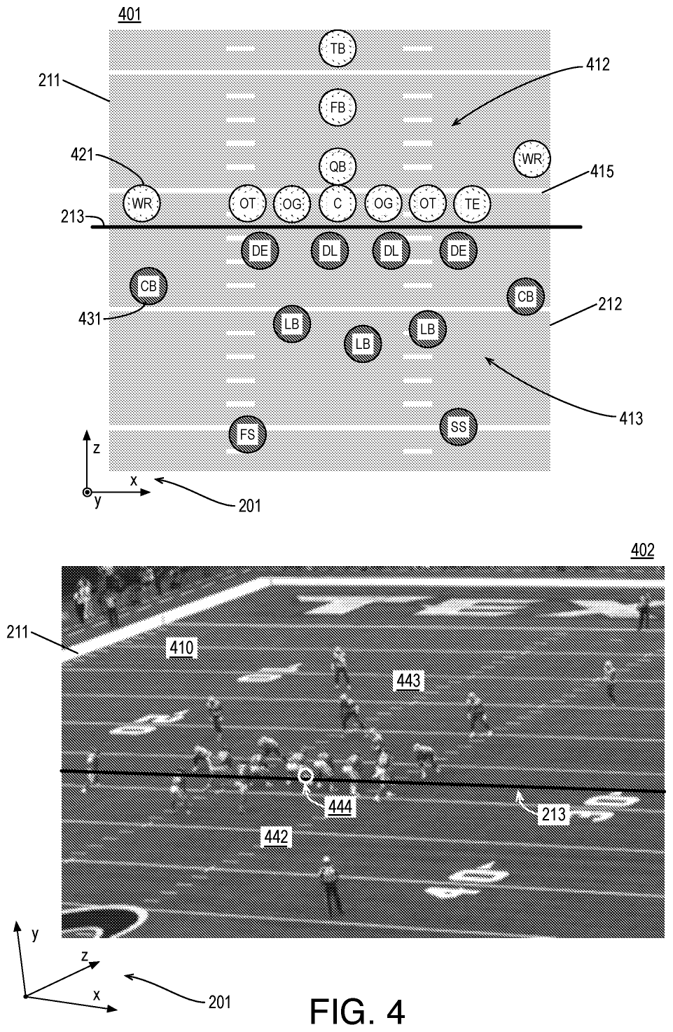

FIG. 4 illustrates a top down view of an example formation 401 for detection and a camera view presented by a video picture 402 of another example formation 410, arranged in accordance with at least some implementations of the present disclosure. As shown, formation 401 includes an offensive team formation 412 that includes eleven offensive players 421 (as indicated by dotted circles) and a defensive team formation 413 that includes eleven defensive players 431 (as indicated by dark gray circles). Also as shown, offensive team formation 412 and defensive team formation 413 are separated by line of scrimmage 213, which is placed at the location of the ball (not shown) and is orthogonal to a z-axis of 3D coordinate system 201 (and parallel to the x-axis) such that the z-axis is parallel to sidelines 211, 212. Furthermore, line of scrimmage 213 is parallel to any number of yard lines 415, which are parallel to the x-axis and orthogonal to the z-axis of 3D coordinate system 201.

In formation 401, the following abbreviations are used for offensive players 421 and defensive players 431: wide receiver (WR), offensive tackle (OT), offensive guard (OG), center (C), tight end (TE), quarterback (QB), fullback (FB), tailback (TB), cornerback (CB), defensive end (DE), defensive lineman (DL), linebacker (LB), free safety (FS), and strong safety (SS). Other positions and characteristics are available. Notably, in the context of formation 401, it is desirable to identify such positions as some can be translated to key players (i.e., WR, QB, TE, FB, TB, CB, FS, SS) where the ball is likely to go. The techniques discussed herein may identify such player position or provide likelihood scores that each person is a key player, or any video picture other suitable data indicative of key players or persons.

Similarly, video picture 402 shows formation 410 including an offensive formation 442, a defensive formation 443, and line of scrimmage 213 at a position of ball 444 and orthogonal to sideline 211 and the z-axis of 3D coordinate system 201. Players of offensive formation 442 and defensive formation 443 are not labeled with position identifiers in video picture 402 for the sake of clarity of presentation. Notably, in formations that are desired to be detected in American football, the formations such as formation 401 includes offensive players 421 and defensive players 431 spatially separated in the z-axis and most or many of players 421, 431 located around line of scrimmage 213 such that the formation desired to be detected in American football may be characterized as a “line setting”. Such line setting formations are likely the beginning of an offense down, during which both offensive and defensive players begin in a largely static formation and then move rapidly from the static formation during play.

With reference to formation detection module 106 of FIG. 1 and formation 401 of FIG. 4, 3D coordinate system 201 (x, y, z) is used to establish 3D positions of the players and the ball (as well as providing a coordinate system for their velocities and accelerations). In 3D coordinate system 201, the y-axis represents height, the x-axis is parallel to yard lines 415, and the z-axis is parallel to sidelines 211, 212. In some embodiments, formation detection as performed by formation detection module 106 is only dependent on (x, z) coordinates of players 421, 431. Based on received player 3D coordinates (x, y, z) as provided by person data 114, formation detection module 106 applies decision operations or functions to detect a desired formation such as the line setting formation applicable to American football and other sporting events.

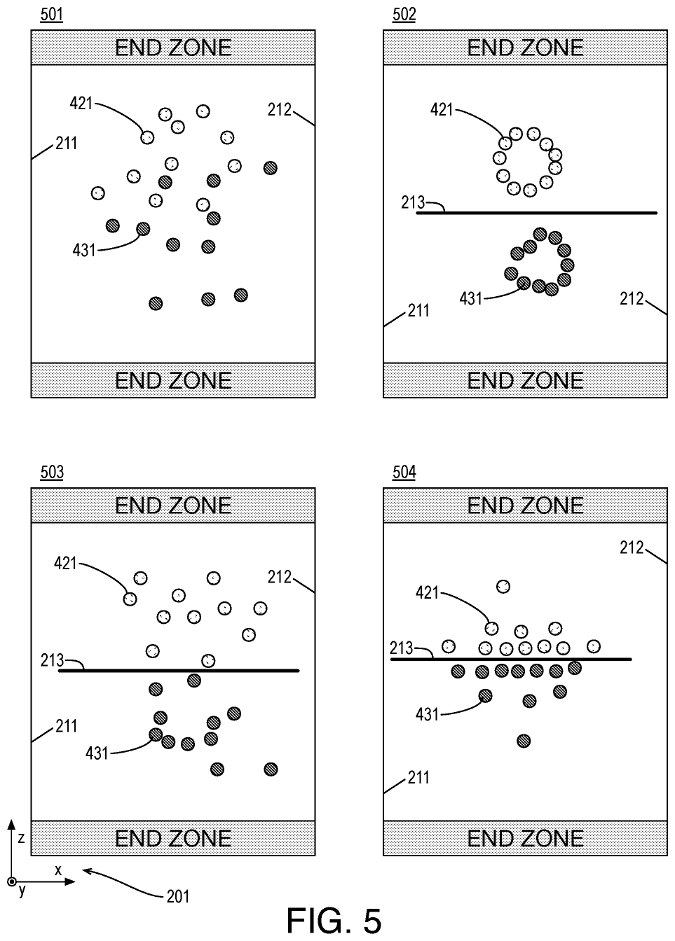

FIG. 5 illustrates top down views of exemplary formations 501, 502, 503, 504 of players in arrangements that are common during a sporting event, arranged in accordance with at least some implementations of the present disclosure. In FIG. 5, several relatively common formations 501, 502, 503, 504 of person arrangements that occur during an American football game are presented. As used herein, the term arrangement of persons indicates the relative spatial locations of the persons in 3D space or in a 2D plane. For example, formations 501, 502, 503 are not formations or arrangements of persons that are desired to be detected while formation 504 is desired to be detected. The term formation herein may apply to an arrangement of persons in 3D space (x, y, z) or in a 2D plane (x, z). Notably, a formation of an arrangement of persons may be desired to be detected or not. As used herein the terms predefined, desired, template, or similar terms indicate the formation is one that is to be detected as opposed to one that is not to be detected. That is, a formation may meet certain tests or criteria and therefore be detected as being a predefined formation, predetermined formation, desired formation, formation matching a template, or the like and may be contrasted from an undesired formation for detection, or the like. It is noted that the terms formation time instance or formation period indicate a predefined formation has been detected for the time instance or period.

As shown in FIG. 5, formation 501 includes an arrangement of detected persons such as offensive players 421 (as indicated by dotted circles) and defensive players 431 (as indicated by dark gray circles). In the context of a sporting event such as an American football game, formation 501 is representative of a play in progress where offensive players 421 and defensive players 431 are moving quickly and the teams are mingled together. It is noted that formation 501 is not advantageous for the detection of key players due to such motion and mingling. For example, formation 501 may be characterized as a moving status formation.

Formation 502 includes an arrangement of offensive players 421 and defensive players 431 where each of the teams are huddled in roughly circular arrangements often for the discussion of tactics prior to a next play in a sporting event such as an American football game. Notably, formation 502 is indicative that a next play is upcoming; however, the circular arrangements of players 421, 431 provides little or no information as to whether they are key players. Furthermore, although formation 502 is often prior to a next play, in some cases a timeout is called or a commercial break is taken and therefore, formation 501 is not advantageous for the detection of key players. For example, formation 501 may be characterized as a circle status or huddle status formation.

Formation 503 includes an arrangement of offensive players 421 and defensive players 431 where a play has ended and each team is slowly moving from formation 501 to another formation such as formation 502, for example, or even formation 504. For example, after a play (as indicated by formation 501), offensive players 421 and defensive players 431 may be moving relatively slowly with respect to a newly established line of scrimmage 213 (as is being established by a referee) to formation 502 or formation 504. For example, formation 503 is indicative that a play has finished and a next play is upcoming; however, the arrangement of players 421, 431 in formation 503 again provides little or no information as to which players are key players. For example, formation 503 may be characterized as an ending status or post play status formation.

Formation 504, in contrast to formations 501, 502, 503, includes an arrangement of offensive players 421 and defensive players 431 with respect to line of scrimmage 213 where offensive players 421 are in a predefined formation (of many available predefined formations that all meet predefined criteria as discussed herein) based rules of the game and established tactics that is ready to attack defensive players 431. Similarly, defensive players 431 are in a predefined formation (of many available predefined formations that all meet predefined criteria as discussed herein) that is ready to offensive players 421. Such predefined formations typically include key players at the same or similar relative positions, having the same or similar jersey numbers, and so on. Therefore, formation 504 may provide a structured data set to determine key players among offensive players 421 and defensive players 431 for tracking, virtual camera view generation, etc.

Returning to FIG. 1, it is the task of formation detection module 106 to determine whether an arrangement of persons meets predetermined criteria that generalize the characteristics of predetermined formations that are of interest and define a predetermined formation of a pre-play arrangement that is likely to provide reliable and accurate key player or person information.

In some embodiments, formation detection module 106 detects a desired predetermined formation based on the arrangement of persons in the scene (i.e., as provided by person data 114) using two criteria: a first that detects team separation and a second that validates or detects alignment to line of scrimmage 213. For example, system 100 may proceed to key persons detection module 107 from formation detection module 106 only if both criteria are met. Otherwise, key persons detection module 107 processing is bypassed until a desired predetermined formation is detected.

In some embodiments, the team separation detection is based on a determination as to whether there is any intersection of the two teams in the z-axis (or any axis applied parallel to sidelines 211, 212). For example, using z-axis, a direction in the scene is established and separation is detected using the axis or direction in the scene. In some embodiments, spatial separation or no spatial overlap is detected when a minimum displacement person along the axis or direction from a first group is further displaced along the axis or direction than a maximum displacement person along the axis or direction from a second group. For example, a first person of the first team that has a maximum z-axis value (i.e., max z-value) is detected and a second person of the second team that has a minimum z-axis value (i.e., min z-value) is also detected. If the minimum z-axis value for the second team is greater than the maximum z-axis value for the first team, then separation is established. Such techniques may be used when it is known the first team is expected to be on the minimum z-axis side of line of scrimmage 113 and the second team is expected to be on the maximum z-axis side of line of scrimmage 113. If such information is not known the process may be repeated using the teams on the opposite sides (or directions along the axis) to determine if separation is established.

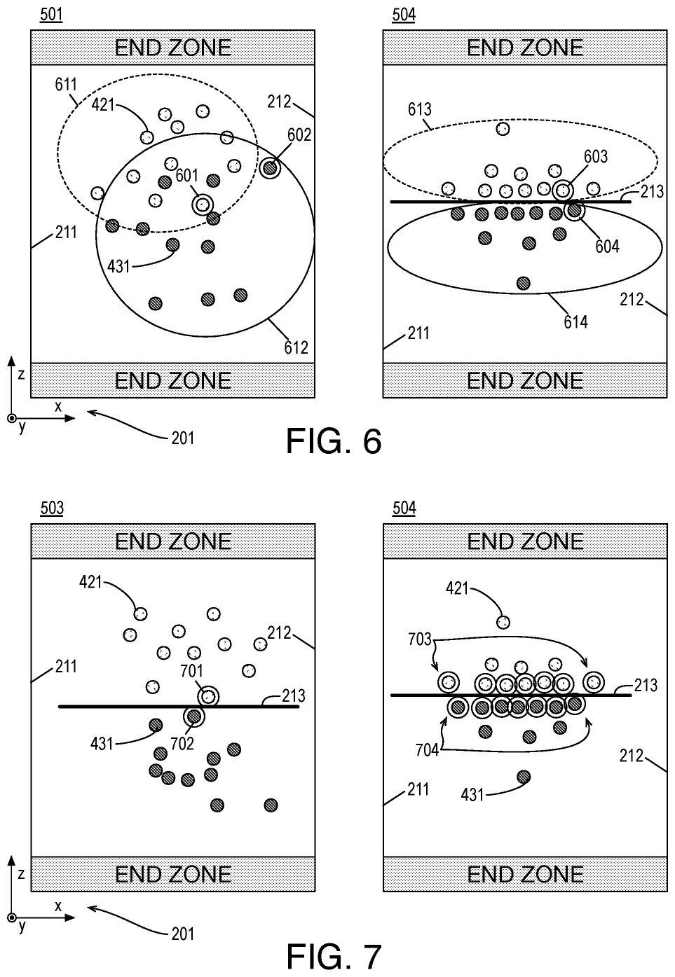

FIG. 6 illustrates top down views of team separation detection operations applied to exemplary formations 501, 504, arranged in accordance with at least some implementations of the present disclosure. As discussed, to determine whether two teams (or subgroups of persons) are separated, a maximum z-value for a first team and a minimum z-value for a second team are compared and, if the minimum z-value for the second team exceeds the maximum z-value for the first team, separation is detected. In FIG. 6, team 1 is illustrated using dotted white circles and team 2 is illustrated using dark gray circles. As shown, in formation 501, a team 1 player circle 611 may encompass offensive players 421 of team 1 and a team 2 player circle 612 may encompass defensive players 431 of team 2. Such player circles 611, 612 indicate spatial overlap of offensive players 421 and defensive players 431.

For purposes of spatial overlap detection, in formation 501, a minimum z-value player 601 of team 1 (as illustrated by being enclosed in a circle) is detected by comparing the z-axis positions of all of offensive players 421 such that the z-value of player 601 is the lowest of all of offensive players 421. For example, the z-value of player 601 may be detected as min(TEAM1_{z}) where min provides a minimum function and TEAM1_{z} represents each z-value of the players of team 1 (i.e., offensive players 421). Similarly, a maximum z-value player 602 of team 2 (as illustrated by being enclosed circle) is detected by comparing the z-axis positions of defensive players 431 such that the z-value of player 602 is the greatest of all of defensive players 431. For example, the z-value of player 602 may be detected as max(TEAM2_{z}) where max provides a maximum function and TEAM2_{z} represents each z-value of team 2 (i.e., defensive players 431).

The z-values of player 601 and 602 are then compared. If the z-value of minimum z-value player 601 is greater than the z-value of maximum z-value player 602, separation is detected. Otherwise, separation is not detected. For example, if min(TEAM1_{z})>max(TEAM2_{z}), separation detected; else separation not detected.

In the context of formation 501, the z-value of minimum z-value player 601 is not greater than the z-value of maximum z-value player 602 (i.e., the z-value of minimum z-value player 601 is less than the z-value of maximum z-value player 602). Therefore, as shown in FIG. 6, separation of offensive players 421 and defensive players 431 is not detected because full spatial overlap in the z-axis is not detected. In such contexts, with reference to FIG. 1, key persons detection module 107 processing is bypassed.

Moving to formation 504, a team 1 player circle 613 may encompass offensive players 421 of team 1 and a team 2 player circle 614 may encompass defensive players 431 of team 2. Such player circles 613, 614 indicate no spatial overlap (i.e., spatial separation) of offensive players 421 and defensive players 431. Also, in formation 504, a minimum z-value player 603 of team 1 (as illustrated by being enclosed circle) is detected by comparing the z-axis positions of all of offensive players 421 such that the z-value of player 603 is again the lowest of all of offensive players 421 (e.g., min(TEAM1_{z})). Furthermore, a maximum z-value player 604 of team 2 (as illustrated by being enclosed circle) is detected by comparing the z-axis positions of all of defensive players 431 such that the z-value of player 604 is the greatest of all of defensive players 431 (e.g., max(TEAM2_{z})). For formation 504, the z-values of player 603 and 604 are compared and, if the z-value of minimum z-value player 603 is greater than the z-value of maximum z-value player 604, separation is detected, and, otherwise, separation is not detected (e.g., if min(TEAM1_{z})>max(TEAM2_{z}), separation detected; else separation not detected).

In the context of formation 504, the z-value of minimum z-value player 603 is greater than the z-value of maximum z-value player 604 and, therefore, as shown in FIG. 6, spatial separation of offensive players 421 and defensive players 431 is detected (e.g., via a spatial separation test applied along the z-axis). It is noted that such separation detection differentiates formation 501 from formations 502, 503, 504. Next, based on such separation detection, of a formation of interest is validated or detected, or not, based on arrangement of persons with respect to line of scrimmage 213.

In some embodiments, line of scrimmage 213 is then established. In some embodiments, line of scrimmage 213 is established as a line orthogonal to the z-axis (and parallel to the x-axis) that runs through a detected ball position (not shown). In some embodiments, line of scrimmage 213 is established as a midpoint between the z-value of minimum z-value player 603 and the z-value of maximum z-value player 604 as provided in Equation (1):

z_{line of scrimmage}=(min(TEAM1_{z})+max(TEAM2_{z}))/2 (1)

where z_{line of scrimmage} is the z-axis value of line of scrimmage 213, min(TEAM1_{z}) is the z-value of player 603 and max(TEAM2_{z}) is the z-value of maximum z-value player 604, both as discussed above.

For example, formations that meet the team separation test are further tested to determined whether the formation is a predetermined or desired formation based on validation of player arrangement with respect to line of scrimmage 213. Given the z-axis value of line of scrimmage 213, a number of players from offensive players 421 and defensive players 431 that are within, in the z-dimension, a threshold distance of line of scrimmage 213 are detected. The threshold distance may be any suitable value. In some embodiments, the threshold distance is 0.1 meters. In some embodiments, the threshold distance is 0.25 meters. In some embodiments, the threshold distance is 0.5 meters. In some embodiments, the threshold distance is not more than 0.5 meters. In some embodiments, the threshold distance is not more than 1 meter.

The number of players within the threshold distance is then compared to a number of players threshold. If the number of players within the threshold distance meets or exceeds the number of players threshold, the formation is validated as a predetermined formation and processing as discussed with respect to key persons detection module 107 is performed. If not, such processing is bypassed. The number of players threshold may be any suitable value. In some embodiments, the number of players threshold is 10. In some embodiments, the number of players threshold is 12. In some embodiments, the number of players threshold is 14. Other threshold values such as 11, 13, and 15 may be used and the threshold may be varied based on the present sporting event. As discussed, if the number of players within the threshold distance compares favorably to the threshold (e.g., meets or exceeds the threshold number of persons), a desired formation is detected and, if the number of players within the threshold distance compares unfavorably to the threshold (e.g., does not exceed or fails to meet the threshold number of persons), a desired formation is not detected.

FIG. 7 illustrates top down views of line of scrimmage verification operations applied to exemplary formations 503, 504, arranged in accordance with at least some implementations of the present disclosure. As discussed, to determine whether two teams (or subgroups of persons) are in a desired predetermined formation based on meeting a line setting characteristic, a number of players within a threshold distance of line of scrimmage 213 is compared to a threshold and, only if the number of players compares favorably to the threshold, the line setting characteristic is detected. In some embodiments, the total number of players from both teams is compared to the threshold. In some embodiments, a minimum number of players from each team must meet a number of players threshold (e.g., a threshold of 5, 6, or 7).

In FIG. 7, a distance between each of offensive players 421 (as indicated by dotted circles) and line of scrimmage 213 is determined (e.g., as a distance in on the z-direction: distance=|z_{player}−z_{line of scrimmage}|, where z_{player} is the z-axis value or location of each player). The distance for each player from line of scrimmage 213 is then compared to the distance threshold as discussed above. As shown with respect to formation 503, only offensive player 701 (as indicated by being enclosed in a circle) is within the threshold distance. In a similar manner, a distance between each of defensive players 423 (as indicated by dark gray circles) and line of scrimmage 213 is determined in the same manner. The distance from line of scrimmage 213 for each player is then compared to the distance threshold. In formation 503, only offensive player 702 (as indicated by being enclosed in a circle) is within the threshold distance. Therefore, in formation 503, only two players are within the threshold distance of line of scrimmage 213 and formation 503 is not verified as a predetermined formation (as the number of players within a threshold distance of line of scrimmage 213 is less than the threshold number of person), line setting formation, or the like and formation 503 is discarded. That is, key persons detection module 107 is not applied as formation 503 is not a desired formation for key person detection. It is noted that formation 502 (please refer to FIG. 5) also fails line of scrimmage or line setting verification as no players are within the threshold distance of line of scrimmage 213.

Turning now to formation 504, each of offensive players 421 and defensive players 431 are again tested to determine whether they are within a threshold distance of line of scrimmage 213 as discussed above (e.g., if |z_{player}−z_{line of scrimmage}|<TH, then within the threshold distance and the player is included in the count). In formation 504, seven offensive players 703 (as indicated by being enclosed in circles) are within the threshold distance and seven defensive players 704 (as indicated by being enclosed in circles) are within the threshold distance. Therefore, in formation 504, fourteen players are within the threshold distance of line of scrimmage 213 and formation 504 is verified as a predetermined formation since the number of players exceeds the number of player threshold (e.g., threshold of 10, 11, 12, 13, or 14 depending on context).

In response to formation 504 meeting the team separation test and the line setting formation test, with reference now to FIG. 1, person data 114 and object data 115 corresponding to formation 504 are provided to key persons detection module 107 for key person detection as discussed herein below. It is noted that person data 114 and object data 115 may correspond to the time instance of formation 504, to a number of time instances prior to and/or subsequent to the time instance of formation, or the like. Notably, for person velocity and acceleration information of person data 114, historical velocity and acceleration may be used (e.g., maximum velocity and acceleration, average in-play velocity and acceleration, or the like). Notably, detection of a valid formation by formation detection module 106 for a particular time instance triggers application of key persons detection module 107.

As discussed, key persons detection module 107 may include graph node features extraction module 108, graph node classification module 109, and estimation of key person identification module 110. Such modules may be applied separately or they may be applied in combination with respect to one another to generate key person indicators 121. Key person indicators 121 may include any suitable data structure indicating the key persons from the persons in the detected formation such as a flag for each such key person, a likelihood each person is a key person, a player position for each key person, a player position for each person, or the like.

In some embodiments, each person in a desired detected formation (e.g., each of offensive players 421 and defensive players 431) are treated as a node of a graph or graphical representation of the arrangement of persons from which a key person or persons are to be detected. For each of such nodes (or persons) a feature vector is then generated by graph node features extraction module 108 to provide feature vectors 116. Each of feature vectors 116 may include, for each person or player, any suitable features such as a location of the person (or player) in 3D space, a subgroup (or team) of the person (or player), a person (or player) identification of the person (or player) such as a uniform number, a velocity of the person (or player), an acceleration of the person (or player), and a sporting object location within the scene for a sporting object corresponding to the sporting event. Other features may be used.

Furthermore, an adjacent matrix is generated using at least the position data from the feature vectors 116. As discussed, the adjacent matrix indicates nodes that are connected (e.g., adjacent matrix values of 1) and those that are not connected (e.g., adjacent matrix values of 0). The adjacent matrix may be generated using any suitable technique or techniques as discussed herein below. In some embodiments, the adjacent matrix is generated by graph node classification module 109 based on distances between each node in 3D space such that a connection is provided when the nodes are less than or equal to a threshold distance apart and no connection is provide when the nodes are greater than the threshold distance from one another.

Feature vectors 116 and the adjacent matrix are then provided to a classifier such as a pretrained graph neural network (GNN) such as a graph attentional network, which generates outputs based on the input feature vectors 116 and adjacent matrix. In some embodiments, the GNN is a graph attentional network (GAT). The output for each node may be any suitable data structure that may be translated to a key person identifier. In some embodiments, the output indicates the most likely position (e.g., team sport position) of each node. In some embodiments, the output indicates a likelihood score (e.g., ranging from 0 to 1) of each position for each node. Such outputs may be used by key person identification module 110 to generate key person indicators 121, which may include any data structure as discussed herein. In some embodiments, key person identification module 110 uses likelihood scores to select a position for each node (player) using a particular limitation on the numbers of such positions (e.g., only one QB, up to 3 RBs, etc.).

As discussed, each person or player is treated as a node in a graph or graphical representation for later application of a GNN, a GAT, or other classifier. In some embodiments, a graph like data structure is generated as shown in Equation (2):

G=(V,E,X) (2)

where V is the set of nodes, E is a set of edges (or connections), and X is the set of node features (i.e., input feature vectors 116). Notably, herein the term edge indicates a connection between nodes as defined by the adjacent matrix (and no edge indicates no connection). In some embodiments, X ∈ [symbol] ^{n×d}. Next, assuming \vec{x}ᵢ ∈ X, \vec{x}₁={x₁, x₂, . . . , x_{d}} with n indicating the number of nodes and d indicating the length of the feature vector of each node, \vec{x}ᵢ provides the feature vector (or node feature) of each node i.

Next, with νᵢ ∈ V indicating a node and eᵢⱼ=(νᵢ, νⱼ) ∈ E indicating an edge, the adjacent matrix, A, is determined as an N×N matrix such that Aᵢⱼ=1 if eᵢⱼ ∈ E and Aᵢⱼ=0 if eᵢⱼ ∉ E. Thereby, the adjacent matrix, A, and the node features, X, define graph or graph like data that are suitable for classification using a GNN, a GAT, or other suitable classifier.

Such graph or graph like data are provided to the pretrained classifier as shown with respect to a GAT model in Equation (3):

y=f_{GAT}(A,X,W,b) (3)

where y indicates the prediction of the GAT model or other classifier, f_{GAT}(·) indicates the GAT model, and W and b indicate the weights and biases, respectively, of the pretrained GAT model or other pretrained classifier. As discussed, the output, y, may include any suitable data structure such as a most likely position (e.g., team sport position) of each node, a likelihood score of each position for each node (e.g., a score for each position for each node), a likelihood, each node is a key person, or the like.

As discussed with respect to Equations (2) and (3), an adjacent matrix and feature vectors are generated for application of the classifier. In some embodiments, the adjacent matrix is generated based on distances (in 3D space as defined by 3D coordinate system 201) between each pairing of nodes in the graph or graph-like structure. If the distance is less than a threshold (or not greater than the threshold), a connection or edge is provided and, otherwise, no connection or edge is provided. For example, Aᵢⱼ=1 may indicate a connection or edge is established between node i and node j while Aᵢⱼ=0 indicates no connection or edge between nodes i and j. In some embodiments, the adjacent matrix is generated by determining a distance (e.g., a Euclidian distance) between the players corresponding to the nodes in 3D space. A distance threshold is then established and if the distance is less than the threshold (or does not exceed the threshold), a connection is established. The distance threshold may be any suitable value. In some embodiments, the distance threshold is 2 meters. In some embodiments, the distance threshold is 3 meters. In some embodiments, the distance threshold is 5 meters. Other distance threshold values may be employed. In some embodiments, if the distance between players is less than 2 meters, an edge is established between the nodes of the players, and, otherwise, no edge is established.

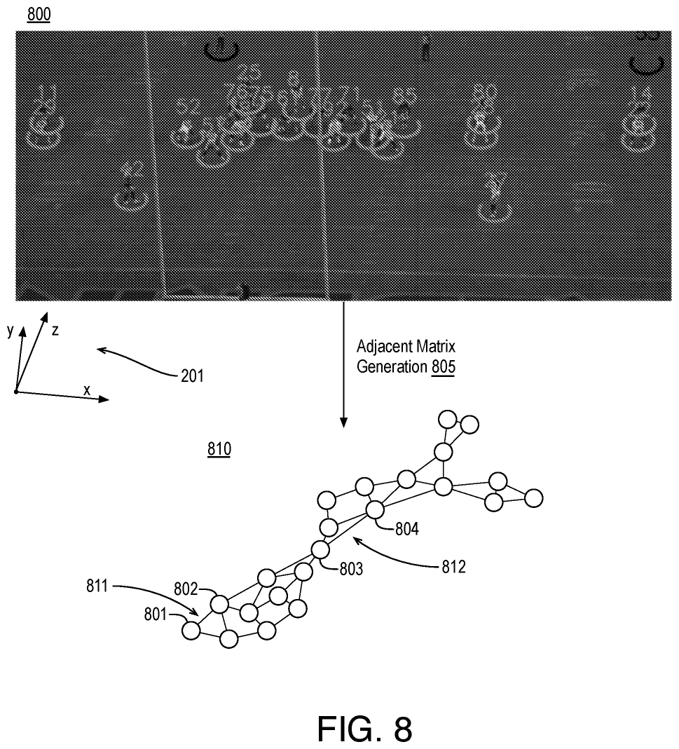

FIG. 8 illustrates an example graph-like data structure 810 generated based on person data as represented by an example formation 800 via an adjacent matrix generation operation 805, arranged in accordance with at least some implementations of the present disclosure. As discussed herein, for each player of formation 800, person data 114 indicates features of the player including their location in 3D space as defined by 3D coordinate system 201. Each player in formation 800 is then represented by a node 801, 802, 803, 804 of graph-like data structure 810 and a feature vector for each node 801, 802, 803, 804 is generated as discussed further herein below.

Furthermore, connections 811, 812 are generated using the locations or positions of each player of formation 800 in 3D space (or in the 2D plane). If the distance between any two players is less than a threshold distance a connection of connections 811, 812 is established and, otherwise, no connection is established. In some embodiments, the threshold distance is 2 meters. For example, as shown with respect to nodes 801, 802, a connection 811 (or edge) is provided as the players corresponding to nodes 801, 802 are less than the threshold distance from one another. Similarly, for nodes 803, 804, a connection 812 (or edge) is provided as the players corresponding to nodes 803, 804 are less than the threshold distance from one another. However, no such connection is provided, for example, between nodes 801, 803 as the players corresponding to nodes 801, 803 are greater than the threshold distance from one another.

Turning to discussion of the feature vectors for each of nodes 801, 802, 803, 804 (i.e., feature vectors 116), such feature vectors may be generated using any suitable technique or techniques such as concatenating the values for the pertinent features for each node. For example, for node 801, one or more of player position (i.e., 3D coordinates), player identifier (jersey number), team identification, ball coordinates, player velocity, player acceleration, or others may be concatenated to form the feature vector for node 801. The values for the same categories may be concatenated for node 802, and so on. For example, after generating the adjacent matrix, A, the features of each node (i.e., the node features, X, as discussed with respect to Equation (3)) are generated. For example, for node i, a feature vector \vec{x}ᵢ ∈ X, \vec{x}ᵢ={x₁, x₁, . . . , x_{d}} is generated such that there are d features for each node. Such features may be selected using any suitable technique or techniques such as manually during classifier training. In some embodiments, all features are encoded into digits, and they provided as a vector to the classifier for inference. Table 1 provides exemplary features for each node.

TABLE 1
Example Features of Each Node

| Features | Notes |
|---|---|
| Player 3D coordinates | (x, y, z) of each player |
| Ball 3D coordinates | (x, y, z) of the ball |
| Jersey numbers | Number on jersey |
| Team ID | Team 1 or team 2 |
| Velocity | Motion status of each player |

For example, the features may be chosen based on the characteristics that need to be defined to determine key players based on player positions of the players in exemplary predefined formations. Notably, player locations (e.g., Player 3D coordinates) and team identification (e.g., Team ID) imply particular types of formations and the position identification of the players in such formations. Such position identification, in turn, indicates those key players that are likely to have the ball during the play, make plays of interest to fans, and so on.

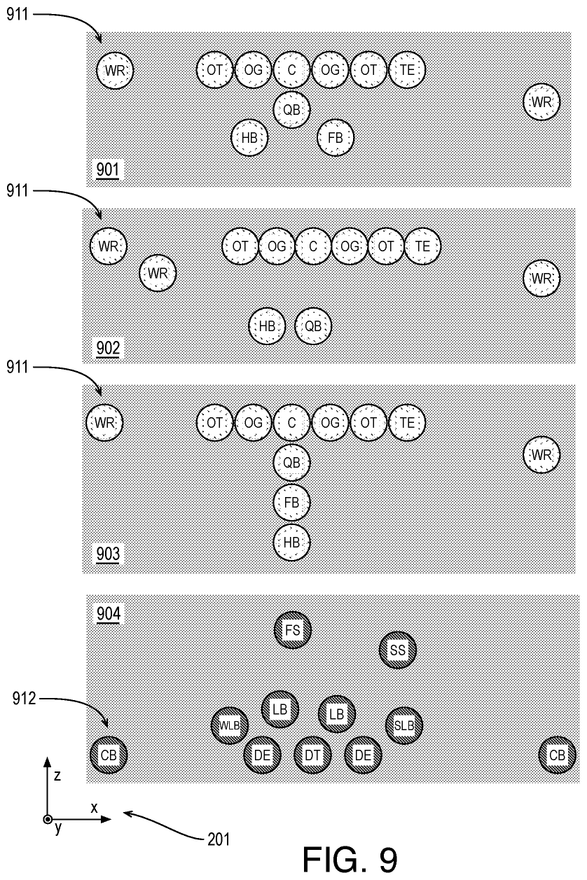

FIG. 9 illustrates top down views of example formations 901, 902, 903, 904 for key person detection, arranged in accordance with at least some implementations of the present disclosure. In FIG. 9, formations 901, 902, 903 are example offensive formations in which offensive players (as indicated by dotted circles) are in example positions. Notably, the rules of a sport may provide restrictions on the arrangement of players and traditional arrangements such as arrangements found to be advantageous in the sport also provide restrictions. Notably, by pretraining a classifier, the classifier may recognize patterns to ultimately provide confidence or likelihood values for each person in formations 901, 902, 903.

For example, in implementation, formation 901 may have corresponding feature vectors for each player including locations and other characteristics (as shown in Table 1 and discussed elsewhere herein). Furthermore, for training purposes, formation 901 illustrates ground truth information for the sport position of each person: WR, OT, OG, C, TE, HB, QB, FB, etc. For example, formation 901 illustrates example ground truth information for the pro set offense. Such ground truth information may be used in a training phase to train a classifier using corresponding example feature vectors generated in training.

In an implementation phase, by applying a classifier to generated feature vectors (i.e., by graph node features extraction module 108) for graph-like nodes corresponding to each of offensive players 911, the classifier generates classification data 117 such as a most likely sport position for each player, a likelihood score for each position for each player, or the like. For example, for the player illustrated as QB, the classifier may provide a score of 0.92 for QB, 0.1 for HB, 0.1 for FB, and a value of zero for other positions. In the same manner, the player illustrated as TE may have a score of 0.8 for TE, a score of 0.11 for OT, and a score of zero for other positions, and so on. Such scores may then be translated to key person indicators 121 (eg by key person identification module 110) using any suitable technique or techniques. In some embodiments, those persons having a position score above a threshold for key positions (i.e., WR, QB, HB (halfback), FB, TE) are identified as key persons. In some embodiments, the highest scoring person or persons (i.e., one for QB, up to three for WR, etc.) for key positions are identified as key persons. Other techniques for selecting key players are available.

Similarly, formations 902, 903 indicate ground truth information for other common offensive formations (i.e., the shotgun formation and the I-formation, respectively) including offensive players 911. As with formation 901 such formations may be used to train a classifier as ground truth information and, in implementation, when presented with feature vectors for the players in offensive formations 902, 903, the classifier (i.e., graph node classification module 109) may generate classification data 117 indicating such positions, likelihoods of such positions, or the like as discussed above.

In a similar manner, defensive formation 904 may correspond to generated feature vectors for each defensive player 912 including locations and other characteristics (as shown in Table 1 and discussed elsewhere herein). In training, defensive formation 904 and such feature vectors may be used to train the classifier. For example, defensive formation 904 may provide ground truth information for a 3-4 defense with the following sport positions illustrated: FS, SS, CB, weak side linebacker (WLB), LB, DE, DT, strong side linebacker (SLB). Furthermore, in implementation, feature vectors as generated by graph node features extraction module 108 are provided to the pretrained classifier as implemented by graph node classification module 109, which provides classification data 117 in any suitable format as discussed herein. It is noted that the classifier may be applied to offensive and defensive formations together or separately. Such classification data 117 is then translated by key person identification module 110 to key person indicators 121 as discussed herein. In some embodiments, those persons having a position score above a threshold for key positions (i.e., CB. FS, SS, LB) are identified as key persons. In some embodiments, the highest scoring person(s) for key positions are identified as key persons.

Returning to discussion of FIG. 8 and Table 1, the features are selected to differentiate key persons, to identify positions in formations, and so on. As discussed, player locations (e.g., Player 3D coordinates) and team identification (e.g., Team ID) imply particular types of formations. Furthermore, the ball location (e.g., Ball 3D coordinates) as provided by object data 115 indicates those players that are close to the ball. Player velocities are associated with particular players (e.g., wide receivers put in motion, defensive players that tend to move such as linebackers, and so on). For example, the velocity feature can be used to determine those who are moving in a line setting period, which is key information for offensive team recognition. In some embodiments, the velocity of a player is a velocity of the player in a number of pictures deemed to be part of a line setting period, for a number of pictures after determination of a line setting time instance, or the like. Player identifications (e.g., Jersey numbers) are also correlated with the positions of players.

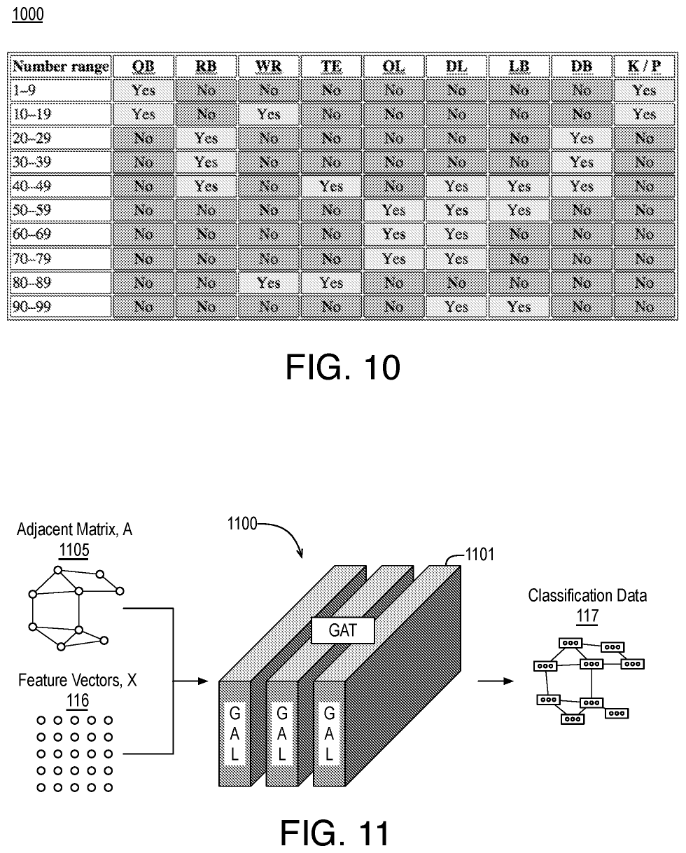

FIG. 10 illustrates an example table 1000 of allowed number ranges for positions in American football, arranged in accordance with at least some implementations of the present disclosure. In FIG. 10, a value of Yes in table 1000 indicates the corresponding position can use the number in accordance with the rules of the game while a value of No indicates the corresponding position cannot use the number. Although illustrated with respect to American football, it is noted other sports have similar rules and, even when rules do not limit such jersey number usage such factors as tradition, lucky numbers, etc. can provide importance to such jersey numbers even in the absence of rules of the game.

For example, FIG. 10 illustrates example number ranges to position correspondences in the National Football League (NFL), which is an American football league. As shown, each position or role of an NFL player has an allowed jersey number range. For example, the jersey number range allowed for quarterbacks (QB) is 1 to 19. Based on such rules and other factors, the jersey number feature of feature vectors 116 is a very valuable feature for the classifier (e.g., GNN, GAT, etc.) to classify or detect key players (i.e., including QB, RB, WR, etc.).

After attaining the adjacent matrix, A, and the features of each node, X (i.e., feature vectors 116), the classifier is applied to generate classification data 117. In some embodiments, the classifier (e.g., as applied by graph node classification module 109) employs a graph attentional network (GAT) including a number of graph attentional layers (GAL) to generate classification data 117.

FIG. 11 illustrates an example a graph attentional network 1100 employing a number of graph attentional layers 1101 to generate classification data 117 based on an adjacent matrix 1105 and feature vectors 116, arranged in accordance with at least some implementations of the present disclosure. Graph attentional network 1100 may have any suitable architecture inclusive of any number of graph attentional layers 1101. In some embodiments, graph attentional network 1100 employs non-spectral learning based on spatial information of each node and other characteristics as provided by feature vectors.

In some embodiments, each of graph attentional layers 1101 (GAL) quantifies the importance of neighbor nodes for every node. Such importance may be characterized as attention and is learnable in the training phase of graph attentional network 1100. For example, graph attentional network 1100 may be trained in a training phase using adjacent matrices and feature vectors generated using techniques discussed herein and corresponding ground truth classification data. In some embodiments, for node i having a feature vector \vec{x}ᵢ={x₁, x₁, . . . , x_{d}} graph attentional layers 1101 (GAL) may generate values in accordance with Equation (4):

\vec{x_{i′}} =σ ( [symbol] aᵢⱼW\vec{xⱼ}) (4)

where σ(·)is an activation function, [symbol] indicates the nodes that neighbor node i (i.e., those nodes connected to node i), and W indicates the weights of graph attentional layers 1101. The term aᵢⱼ indicates the attention for node j to node i.

In some embodiments, the attention term, aᵢⱼ, is generated as shown in Equation (5):

$${α}_{ij} = \frac{exp ( LeakyReLU ( {\vec{a}}^{T} [ W {\vec{x}}_{i} \vert \vert W {\vec{x}}_{j} ] ) )}{{Σ}_{j ∈ {𝒩}_{i}} exp ( LeakyReLU ( {\vec{a}}^{T} [ W {\vec{x}}_{i} \vert \vert W {\vec{x}}_{j} ] ) )} \qquad ( 5 )$$

where LeakyReLU is an activation function and \vec{a}^{T} is the attention kernel.

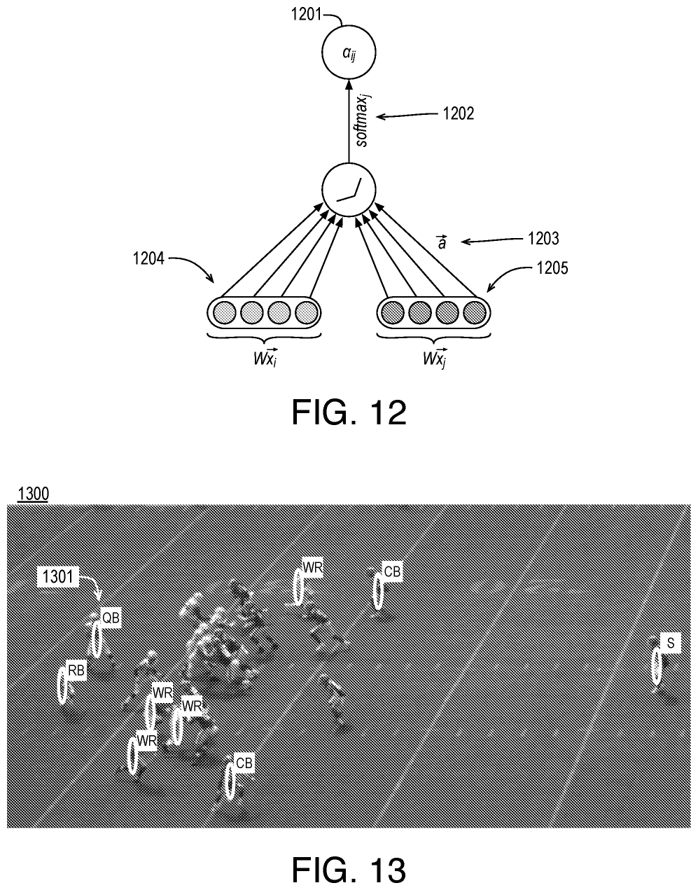

FIG. 12 illustrates an example generation of an activation term 1201 in a graph attentional layer, arranged in accordance with at least some implementations of the present disclosure. As shown in FIG. 12 and with reference to FIG. 5, to generate an attention term 1201 for node j to node i, a softmax function 1202 is applied based on application of an attention kernel 1203 to 20 weighted inputs of the node 1204 and neighboring nodes 1205. For example the attention term, aᵢⱼ, may be a ratio of an exponent of an activation function (e.g., LeakyReLU) as applied to the result of a attention kernel, \vec{a}^{T}, applied based on weighted feature vectors of node i and node j to summed exponents of the activation function as applied to the result of a attention kernel, \vec{a}^{T}, applied based on weighted feature vectors of node i and all neighboring nodes. For example, with \vec{hⱼ} to indicate features of node j updated after the hidden GAL layer, the final classification of node i can be provided as shown in Equation (6):

$${y}_{i} = σ ( \frac{1}{K} {\sum }_{k = 1}^{K} {\sum }_{j ∈ {𝒩}_{i}} {α}_{ij}^{K} {w}^{k} \vec{{h}_{J}} ) \qquad ( 6 )$$

where K indicates the attention heads to generate multiple attention channels to improve the GAL for feature learning.

The techniques discussed herein provide fully automated key person detection with high accuracy. Such key persons may be tracked in the context of volumetric or immersive video generation. For example, using input video 111, 112, 113, a point cloud volumetric model representative of scene 210 may be generated and painted using captured texture. Virtual views from within scene 210 may then be providing using a view of a key person, a view from a perspective a key person, etc.

FIG. 13 illustrates an example key person tracking frame 1300 from key persons detected using predefined formation detection and graph based key person, arranged in accordance with at least some implementations of the present disclosure. As shown in FIG. 13, key person tracking frame 1300 tracks key persons 1301, which are each indicated using an ellipse and a player position. As shown, key persons 1301 includes a QB (who has the ball), a RB, four WRs, and two CBs, all of whom are likely to receive the ball or be close to the ball during the play. The detection of key persons 1301 (i.e., in a formation prior to that represented by frame 1300) may be performed using any techniques discussed herein. The detected persons may then be tracked as shown with respect to key persons 1301 in frame 1300 although such key person data may be used in any suitable context.

The techniques discussed herein provide a formation judgment algorithm such as a line-setting formation detection algorithm based on team separation and line of scrimmage validation. In some embodiments, the formation detection operates in real-time on a one or more CPUs. Such formation detection can be used by other modules such as player tracking modules, key player recognition modules, ball tracking false alarm detection modules, or the like. Furthermore, the techniques discussed herein provide a classifier-based (e.g., GNN-based) key players recognition algorithm, which provides and understanding of the games and key players in contexts. Such techniques also benefit player tracking modules, ball tracking false alarm detection modules, or the like. Although illustrated and discussed with a focus on American football, the discussed techniques are applicable to other team sports with formation in a specific period (hockey, soccer, rugby, handball, etc.) and contexts outside of sports. In some embodiments, key person detection includes finding a desired formation moment, building a relationship graph to represent the formation with each player represented as a node and construction of edges using player-to-player distance, and feeding the graph structured data into a graph node classifier to determine nodes corresponding to key players

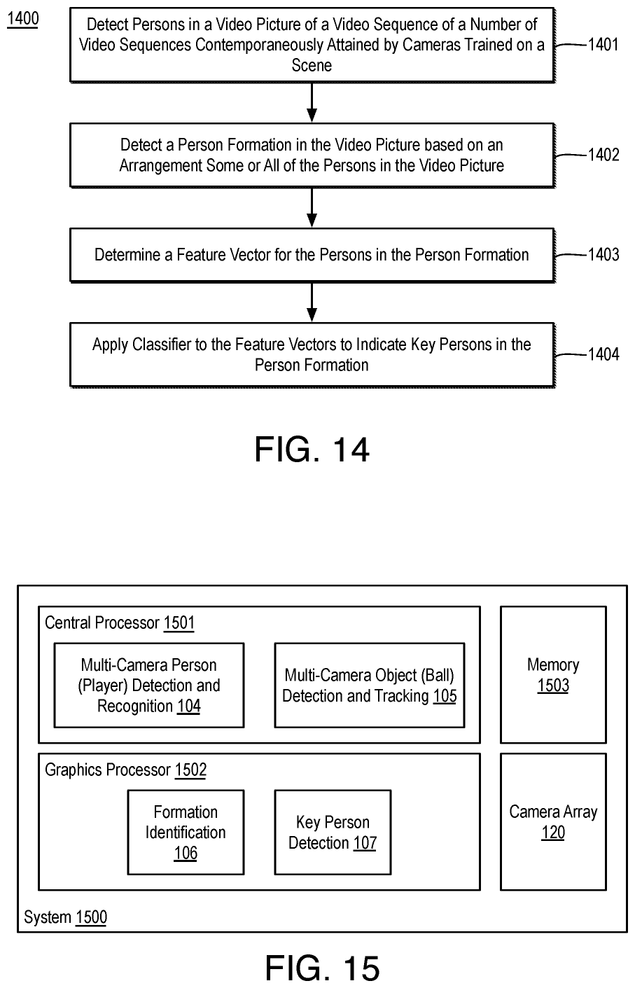

FIG. 14 is a flow diagram illustrating an example process 1400 for identifying key persons in immersive video, arranged in accordance with at least some implementations of the present disclosure. Process 1400 may include one or more operations 1401-1404 as illustrated in FIG. 14. Process 1400 may form at least part of a virtual view generation process, a player tracking process, or the like in the context of immersive video or augmented reality, for example. By way of non-limiting example, process 1400 may form at least part of a process as performed by system 100 as discussed herein. Furthermore, process 1400 will be described herein with reference to system 1500 of FIG. 15.

FIG. 15 is an illustrative diagram of an example system 1500 for identifying key persons in immersive video, arranged in accordance with at least some implementations of the present disclosure. As shown in FIG. 15, system 1500 may include a central processor 1501, a graphics processor 1502, a memory 1503, and camera array 120. Also as shown, graphics processor 1502 may include or implement formation detection module 106 and key persons detection module 107 and central processor 1501 may implement multi-camera person detection and recognition module 104 and multi-camera object detection and recognition module 105. In the example of system 1500, memory 1503 may store video sequences, video pictures, formation data, person data, object data, feature vectors, classifier parameters, key person indicators, or any other data discussed herein.

As shown, in some examples, one or more or portions of formation detection module 106 and a key persons detection module 107 are implemented via graphics processor 1502 and one or more or portions of multi-camera person detection and recognition module 104 and multi-camera object detection and recognition module 105 are implemented via central processor 1501. In other examples, one or more or portions of multi-camera person detection and recognition module 104, multi-camera object detection and recognition module 105, formation detection module 106, and key persons detection module 107 are implemented via central processor 1501, an image processing unit, an image processing pipeline, an image signal processor, or the like. In some examples, one or more or portions of multi-camera person detection and recognition module 104, multi-camera object detection and recognition module 105, formation detection module 106, and key persons detection module 107 are implemented in hardware as a system-on-a-chip (SoC). In some examples, one or more or portions of multi-camera person detection and recognition module 104, multi-camera object detection and recognition module 105, formation detection module 106, and key persons detection module 107 are implemented in hardware via a FPGA.

Graphics processor 1502 may include any number and type of image or graphics processing units that may provide the operations as discussed herein. Such operations may be implemented via software or hardware or a combination thereof. For example, graphics processor 1502 may include circuitry dedicated to manipulate and/or analyze images obtained from memory 1503. Central processor 1501 may include any number and type of processing units or modules that may provide control and other high level functions for system 1500 and/or provide any operations as discussed herein. Memory 1503 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 1503 may be implemented by cache memory. In an embodiment, one or more or portions of multi-camera person detection and recognition module 104, multi-camera object detection and recognition module 105, formation detection module 106, and key persons detection module 107 are implemented via an execution unit (EU) of graphics processor 1502. The EU may include, for example, programmable logic or circuitry such as a logic core or cores that may provide a wide array of programmable logic functions. In an embodiment, one or more or portions of multi-camera person detection and recognition module 104, multi-camera object detection and recognition module 105, formation detection module 106, and key persons detection module 107 are implemented via dedicated hardware such as fixed function circuitry or the like. Fixed function circuitry may include dedicated logic or circuitry and may provide a set of fixed function entry points that may map to the dedicated logic for a fixed purpose or function.

Returning to discussion of FIG. 14, process 1400 begins at operation 1401, where persons are detected in a video picture of a video sequence such that the sequence is one of a number of video sequences contemporaneously attained by cameras trained on a scene. The persons may be detected using any suitable technique or techniques based on the video picture, simultaneous video pictures from other views, and/or video pictures temporally prior to the video picture. In some embodiments, detecting the persons includes person detection and tracking based on the scene.

Processing continues at operation 1402, where a predefined person formation corresponding to the video picture is detected based on an arrangement of at least some of the persons in the scene. As discussed, the persons may be arranged in any manner and a predetermined or predefined person formation based on particular characteristics is detected based on the arrangement. In some embodiments, detecting the predefined person formation includes dividing the detected persons into first and second subgroups and determining whether the first and second groups of persons overlap spatially with respect to an axis applied to the scene such that the predefined person formation is detected in response to no spatial overlap between the first and second groups. In some embodiments, determining whether the first and second groups of persons overlap spatially includes identifying a first person of the first subgroup that is a maximum distance along the axis among the persons of the first subgroup and a second person of the second subgroup that is a minimum distance along the axis among the persons of the second subgroup and detecting no spatial overlap between the first and second groups in response to the second person being a greater distance along the axis than the first person.

In some embodiments, further includes detecting a number of persons from the first and second subgroups that are within a threshold distance of a line dividing the first subgroup and the second subgroup, such that the line is orthogonal to the axis applied to the scene, and the predefined person formation is detected in response to the number of persons within the threshold distance of the line exceeding a threshold number of persons. In some embodiments, the scene includes a football game, the first subgroup is a first team in the football game, the second subgroup is a second team in the football game, the axis is parallel to a sideline of the football game, and the line is a line of scrimmage of the football game.

Processing continues at operation 1403, where a feature vector is generated for at least each of the persons in the predefined person formation. The feature vector for each person may include any characteristics or features relevant to the scene. In some embodiments, the scene includes a sporting event, the persons are players in the sporting event, and a first feature vector of the feature vectors includes a location of a player, a team of the player, a player identification of the player, and a velocity of the player. In some embodiments, the first feature vector further includes a sporting object location within the scene for a sporting object corresponding to the sporting event such as a ball or the like.

Processing continues at operation 1404, where a classifier is applied to the feature vectors to indicate one or more key persons from the persons in the predefined person formation. The classifier may be any classifier discussed herein such as a GNN, GAT, or the like. In some embodiments, the classifier is a graph attention network applied to a number of nodes, each including one of the feature vectors, and an adjacent matrix that defines connections between the nodes, such each of the nodes is representative of one of the persons in the predefined person formation. In some embodiments, process 1400 further includes generating the adjacent matrix via evaluation of available pairings of the nodes by applying a connection for a first pairing of first and second nodes where a first distance between first and second persons in the scene represented by the first and second nodes, respectively, does not exceed a threshold and providing no connection for a second pairing of third and fourth nodes where a second distance between third and fourth persons in the scene represented by the third and fourth nodes, respectively, exceeds the threshold. The resultant indications of key persons may include any suitable data structure(s). In some embodiments, the indications of one or more key persons include one of a highest probability player position for each of the key persons or a key person probability score for each of the key persons.

Process 1400 may be repeated any number of times either in series or in parallel for any number of formations or pictures. Process 1400 may be implemented by any suitable device(s), system(s), apparatus(es), or platform(s) such as those discussed herein. In an embodiment, process 1400 is implemented by a system or apparatus having a memory to store at least a portion of a video sequence, as well as any other discussed data structures, and a processor to perform any of operations 1401-1404. In an embodiment, the memory and the processor are implemented via a monolithic field programmable gate array integrated circuit. As used herein, the term monolithic indicates a device that is discrete from other devices, although it may be coupled to other devices for communication and power supply.

Various components of the systems described herein may be implemented in software, firmware, and/or hardware and/or any combination thereof. For example, various components of the devices or systems discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the devices or systems, or any other module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

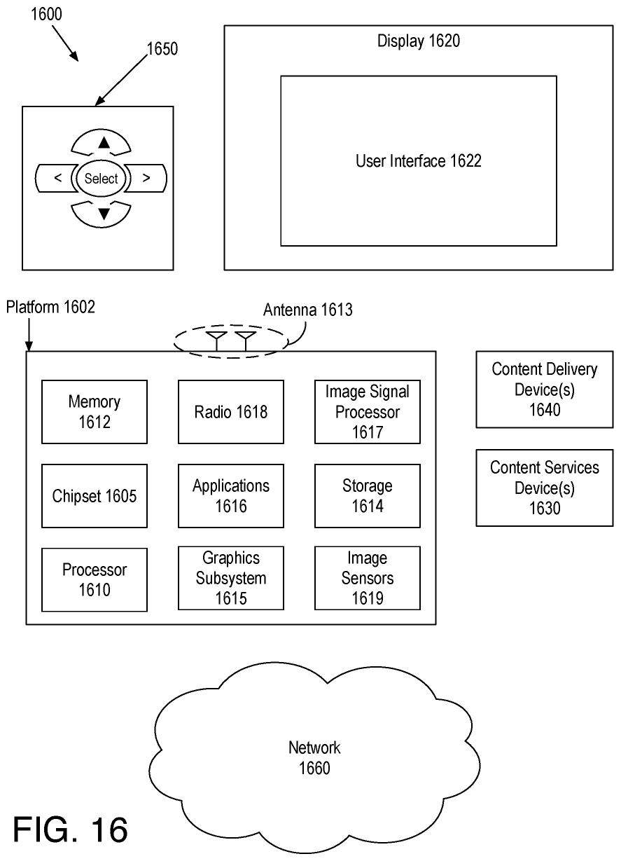

FIG. 16 is an illustrative diagram of an example system 1600, arranged in accordance with at least some implementations of the present disclosure. In various implementations, system 1600 may be a mobile device system although system 1600 is not limited to this context. For example, system 1600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), a surveillance camera, a surveillance system including a camera, and so forth.

In various implementations, system 1600 includes a platform 1602 coupled to a display 1620. Platform 1602 may receive content from a content device such as content services device(s) 1630 or content delivery device(s) 1640 or other content sources such as image sensors 1619. For example, platform 1602 may receive image data as discussed herein from image sensors 1619 or any other content source. A navigation controller 1650 including one or more navigation features may be used to interact with, for example, platform 1602 and/or display 1620. Each of these components is described in greater detail below.

In various implementations, platform 1602 may include any combination of a chipset 1605, processor 1610, memory 1612, antenna 1613, storage 1614, graphics subsystem 1615, applications 1616, image signal processor 1617 and/or radio 1618. Chipset 1605 may provide intercommunication among processor 1610, memory 1612, storage 1614, graphics subsystem 1615, applications 1616, image signal processor 1617 and/or radio 1618. For example, chipset 1605 may include a storage adapter (not depicted) capable of providing intercommunication with storage 1614.

Processor 1610 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1610 may be dual-core processor(s), dual-core mobile processor(s), and so forth.

Memory 1612 may be implemented as a volatile memory device such as, but not limited to, a Random Access Memory (RAM), Dynamic Random Access Memory (DRAM), or Static RAM (SRAM).

Storage 1614 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1614 may include technology to increase the storage performance enhanced protection for valuable digital media when multiple hard drives are included, for example.

Image signal processor 1617 may be implemented as a specialized digital signal processor or the like used for image processing. In some examples, image signal processor 1617 may be implemented based on a single instruction multiple data or multiple instruction multiple data architecture or the like. In some examples, image signal processor 1617 may be characterized as a media processor. As discussed herein, image signal processor 1617 may be implemented based on a system on a chip architecture and/or based on a multi-core architecture.

Graphics subsystem 1615 may perform processing of images such as still or video for display. Graphics subsystem 1615 may be a graphics processing unit (GPU) or a visual processing unit (VPU), for example. An analog or digital interface may be used to communicatively couple graphics subsystem 1615 and display 1620. For example, the interface may be any of a High-Definition Multimedia Interface, DisplayPort, wireless HDMI, and/or wireless HD compliant techniques. Graphics subsystem 1615 may be integrated into processor 1610 or chipset 1605. In some implementations, graphics subsystem 1615 may be a stand-alone device communicatively coupled to chipset 1605.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1618 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1618 may operate in accordance with one or more applicable standards in any version.

In various implementations, display 1620 may include any television type monitor or display. Display 1620 may include, for example, a computer display screen, touch screen display, video monitor, television-like device, and/or a television. Display 1620 may be digital and/or analog. In various implementations, display 1620 may be a holographic display. Also, display 1620 may be a transparent surface that may receive a visual projection. Such projections may convey various forms of information, images, and/or objects. For example, such projections may be a visual overlay for a mobile augmented reality (MAR) application. Under the control of one or more software applications 1616, platform 1602 may display user interface 1622 on display 1620.

In various implementations, content services device(s) 1630 may be hosted by any national, international and/or independent service and thus accessible to platform 1602 via the Internet, for example. Content services device(s) 1630 may be coupled to platform 1602 and/or to display 1620. Platform 1602 and/or content services device(s) 1630 may be coupled to a network 1660 to communicate (e.g., send and/or receive) media information to and from network 1660. Content delivery device(s) 1640 also may be coupled to platform 1602 and/or to display 1620.

Image sensors 1619 may include any suitable image sensors that may provide image data based on a scene. For example, image sensors 1619 may include a semiconductor charge coupled device (CCD) based sensor, a complimentary metal-oxide-semiconductor (CMOS) based sensor, an N-type metal-oxide-semiconductor (NMOS) based sensor, or the like. For example, image sensors 1619 may include any device that may detect information of a scene to generate image data.

In various implementations, content services device(s) 1630 may include a cable television box, personal computer, network, telephone, Internet enabled devices or appliance capable of delivering digital information and/or content, and any other similar device capable of uni-directionally or bi-directionally communicating content between content providers and platform 1602 and/display 1620, via network 1660 or directly. It will be appreciated that the content may be communicated uni-directionally and/or bi-directionally to and from any one of the components in system 1600 and a content provider via network 1660. Examples of content may include any media information including, for example, video, music, medical and gaming information, and so forth.

Content services device(s) 1630 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1602 may receive control signals from navigation controller 1650 having one or more navigation features. The navigation features of navigation controller 1650 may be used to interact with user interface 1622, for example. In various embodiments, navigation controller 1650 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 1650 may be replicated on a display (e.g., display 1620) by movements of a pointer, cursor, focus ring, or other visual indicators displayed on the display. For example, under the control of software applications 1616, the navigation features located on navigation controller 1650 may be mapped to virtual navigation features displayed on user interface 1622, for example. In various embodiments, navigation controller 1650 may not be a separate component but may be integrated into platform 1602 and/or display 1620. The present disclosure, however, is not limited to the elements or in the context shown or described herein.

In various implementations, drivers (not shown) may include technology to enable users to instantly turn on and off platform 1602 like a television with the touch of a button after initial boot-up, when enabled, for example. Program logic may allow platform 1602 to stream content to media adaptors or other content services device(s) 1630 or content delivery device(s) 1640 even when the platform is turned “off” In addition, chipset 1605 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1600 may be integrated. For example, platform 1602 and content services device(s) 1630 may be integrated, or platform 1602 and content delivery device(s) 1640 may be integrated, or platform 1602, content services device(s) 1630, and content delivery device(s) 1640 may be integrated, for example. In various embodiments, platform 1602 and display 1620 may be an integrated unit. Display 1620 and content service device(s) 1630 may be integrated, or display 1620 and content delivery device(s) 1640 may be integrated, for example. These examples are not meant to limit the present disclosure.

In various embodiments, system 1600 may be implemented as a wireless system, a wired system, or a combination of both. When implemented as a wireless system, system 1600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 16.

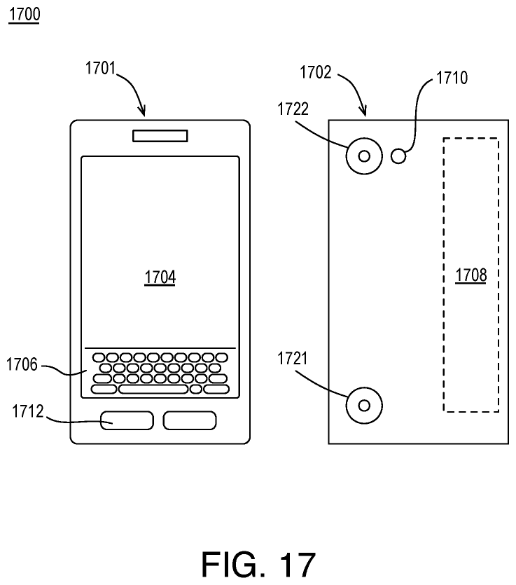

As described above, system 1600 may be embodied in varying physical styles or form factors. FIG. 17 illustrates an example small form factor device 1700, arranged in accordance with at least some implementations of the present disclosure. In some examples, system 1700 may be implemented via device 1700. In other examples, other systems, components, or modules discussed herein or portions thereof may be implemented via device 1700. In various embodiments, for example, device 1700 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smartphone, smart tablet or smart mobile television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be implemented by a motor vehicle or robot, or worn by a person, such as wrist computers, finger computers, ring computers, eyeglass computers, belt-clip computers, arm-band computers, shoe computers, clothing computers, and other wearable computers. In various embodiments, for example, a mobile computing device may be implemented as a smartphone capable of executing computer applications, as well as voice communications and/or data communications. Although some embodiments may be described with a mobile computing device implemented as a smartphone by way of example, it may be appreciated that other embodiments may be implemented using other wireless mobile computing devices as well. The embodiments are not limited in this context.

As shown in FIG. 17, device 1700 may include a housing with a front 1701 and a back 1702. Device 1700 includes a display 1704, an input/output (I/O) device 1706, a color camera 1721, a color camera 1722, an infrared transmitter 1723, and an integrated antenna 1708. In some embodiments, color camera 1721 and color camera 1722 attain planar images as discussed herein. In some embodiments, device 1700 does not include color camera 1721 and 1722 and device 1700 attains input image data (e.g., any input image data discussed herein) from another device. Device 1700 also may include navigation features 1712. I/O device 1706 may include any suitable I/O device for entering information into a mobile computing device. Examples for I/O device 1706 may include an alphanumeric keyboard, a numeric keypad, a touch pad, input keys, buttons, switches, microphones, speakers, voice recognition device and software, and so forth. Information also may be entered into device 1700 by way of microphone (not shown), or may be digitized by a voice recognition device. As shown, device 1700 may include color cameras 1721, 1722, and a flash 1710 integrated into back 1702 (or elsewhere) of device 1700. In other examples, color cameras 1721, 1722, and flash 1710 may be integrated into front 1701 of device 1700 or both front and back sets of cameras may be provided. Color cameras 1721, 1722 and a flash 1710 may be components of a camera module to originate color image data with IR texture correction that may be processed into an image or streaming video that is output to display 1704 and/or communicated remotely from device 1700 via antenna 1008 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following pertain to further embodiments.

In one or more first embodiments, a method for identifying key persons in immersive video comprises detecting a plurality of persons in a video picture of a first video sequence, the first video sequence comprising one of a plurality of video sequences contemporaneously attained by cameras trained on a scene, detecting a predefined person formation corresponding to the video picture based on an arrangement of at least some of the persons in the scene, generating a feature vector for at least each of the persons in the predefined person formation, and applying a classifier to the feature vectors to indicate one or more key persons from the persons in the predefined person formation.

In one or more second embodiments, further to the first embodiment, detecting the predefined person formation comprises dividing the plurality of persons into first and second subgroups and determining whether the first and second groups of persons overlap spatially with respect to an axis applied to the scene, wherein the predefined person formation is detected in response to no spatial overlap between the first and second groups.

In one or more third embodiments, further to the first or second embodiments, determining whether the first and second groups of persons overlap spatially comprises identifying a first person of the first subgroup that is a maximum distance along the axis among the persons of the first subgroup and a second person of the second subgroup that is a minimum distance along the axis among the persons of the second subgroup and detecting no spatial overlap between the first and second groups in response to the second person being a greater distance along the axis than the first person.

In one or more fourth embodiments, further to any of the first through third embodiments, detecting the predefined person formation further comprises detecting a number of persons from the first and second subgroups that are within a threshold distance of a line dividing the first subgroup and the second subgroup, wherein the line is orthogonal to the axis applied to the scene, and the predefined person formation is detected in response to the number of persons within the threshold distance of the line exceeding a threshold number of persons.

In one or more fifth embodiments, further to any of the first through fourth embodiments, the scene comprises a football game, the first subgroup comprises a first team in the football game, the second subgroup comprises a second team in the football game, the axis is parallel to a sideline of the football game, and the line is a line of scrimmage of the football game.

In one or more sixth embodiments, further to any of the first through fifth embodiments, the scene comprises a sporting event, the persons comprise players in the sporting event, and a first feature vector of the feature vectors comprises a location of a player, a team of the player, a player identification of the player, and a velocity of the player.

In one or more seventh embodiments, further to any of the first through sixth embodiments, the first feature vector further comprises a sporting object location within the scene for a sporting object corresponding to the sporting event.

In one or more eighth embodiments, further to any of the first through seventh embodiments, the classifier comprises a graph attention network applied to a plurality of nodes, each comprising one of the feature vectors, and an adjacent matrix that defines connections between the nodes, wherein each of the nodes is representative of one of the persons in the predefined person formation.

In one or more ninth embodiments, further to any of the first through eighth embodiments, the method further comprises generating the adjacent matrix via evaluation of available pairings of the nodes by applying a connection for a first pairing of first and second nodes where a first distance between first and second persons in the scene represented by the first and second nodes, respectively, does not exceed a threshold and providing no connection for a second pairing of third and fourth nodes where a second distance between third and fourth persons in the scene represented by the third and fourth nodes, respectively, exceeds the threshold.

In one or more tenth embodiments, further to any of the first through ninth embodiments, the indications of one or more key persons comprise one of a highest probability player position for each of the key persons or a key person probability score for each of the key persons.

In one or more eleventh embodiments, a device or system includes a memory and one or more processors to perform a method according to any one of the above embodiments.

In one or more twelfth embodiments, at least one machine readable medium includes a plurality of instructions that in response to being executed on a computing device, cause the computing device to perform a method according to any one of the above embodiments.

In one or more thirteenth embodiments, an apparatus includes means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

1-25. (canceled)

26. A system for identifying key persons in immersive video comprising:
a memory to store at least a portion of a video picture of a first video sequence, the first video sequence comprising one of a plurality of video sequences contemporaneously attained by cameras trained on a scene; and
one or more processors coupled to the memory, the one or more processors to:
detect a plurality of persons in the video picture;
detect a predefined person formation corresponding to the video picture based on an arrangement of at least some of the persons in the scene;
generate a feature vector for at least each of the persons in the predefined person formation; and
apply a classifier to the feature vectors to indicate one or more key persons from the persons in the predefined person formation.

27. The system of claim 26, wherein the one or more processors to detect the predefined person formation comprises the one or more processors to:
divide the plurality of persons into first and second subgroups; and
determine whether the first and second groups of persons overlap spatially with respect to an axis applied to the scene, wherein the predefined person formation is detected in response to no spatial overlap between the first and second groups.

28. The system of claim 27, wherein the one or more processors to determine whether the first and second groups of persons overlap spatially comprises the one or more processors to:
identify a first person of the first subgroup that is a maximum distance along the axis among the persons of the first subgroup and a second person of the second subgroup that is a minimum distance along the axis among the persons of the second subgroup; and
detect no spatial overlap between the first and second groups in response to the second person being a greater distance along the axis than the first person.

29. The system of claim 27, wherein the one or more processors to detect the predefined person formation further comprises the one or more processors to:
detect a number of persons from the first and second subgroups that are within a threshold distance of a line dividing the first subgroup and the second subgroup, wherein the line is orthogonal to the axis applied to the scene, and the predefined person formation is detected in response to the number of persons within the threshold distance of the line exceeding a threshold number of persons.

30. The system of claim 29, wherein the scene comprises a football game, the first subgroup comprises a first team in the football game, the second subgroup comprises a second team in the football game, the axis is parallel to a sideline of the football game, and the line is a line of scrimmage of the football game.

31. The system of claim 26, wherein the scene comprises a sporting event, the persons comprise players in the sporting event, and a first feature vector of the feature vectors comprises a location of a player, a team of the player, a player identification of the player, and a velocity of the player.

32. The system of claim 31, wherein the first feature vector further comprises a sporting object location within the scene for a sporting object corresponding to the sporting event.

33. The system of claim 26, wherein the classifier comprises a graph attention network applied to a plurality of nodes, each comprising one of the feature vectors, and an adjacent matrix that defines connections between the nodes, wherein each of the nodes is representative of one of the persons in the predefined person formation.

34. The system of claim 33, the one or more processors to:
generate the adjacent matrix via evaluation of available pairings of the nodes by applying a connection for a first pairing of first and second nodes where a first distance between first and second persons in the scene represented by the first and second nodes, respectively, does not exceed a threshold and providing no connection for a second pairing of third and fourth nodes where a second distance between third and fourth persons in the scene represented by the third and fourth nodes, respectively, exceeds the threshold.

35. The system of claim 26, wherein the indications of one or more key persons comprise one of a highest probability player position for each of the key persons or a key person probability score for each of the key persons.

36. A method for identifying key persons in immersive video comprising:
detecting a plurality of persons in a video picture of a first video sequence, the first video sequence comprising one of a plurality of video sequences contemporaneously attained by cameras trained on a scene;
detecting a predefined person formation corresponding to the video picture based on an arrangement of at least some of the persons in the scene;
generating a feature vector for at least each of the persons in the predefined person formation; and
applying a classifier to the feature vectors to indicate one or more key persons from the persons in the predefined person formation.

37. The method of claim 36, wherein detecting the predefined person formation comprises:
dividing the plurality of persons into first and second subgroups; and
determining whether the first and second groups of persons overlap spatially with respect to an axis applied to the scene, wherein the predefined person formation is detected in response to no spatial overlap between the first and second groups.

38. The method of claim 37, wherein determining whether the first and second groups of persons overlap spatially comprises:
identifying a first person of the first subgroup that is a maximum distance along the axis among the persons of the first subgroup and a second person of the second subgroup that is a minimum distance along the axis among the persons of the second subgroup; and
detecting no spatial overlap between the first and second groups in response to the second person being a greater distance along the axis than the first person.

39. The method of claim 37, wherein said detecting the predefined person formation further comprises:
detecting a number of persons from the first and second subgroups that are within a threshold distance of a line dividing the first subgroup and the second subgroup, wherein the line is orthogonal to the axis applied to the scene, and the predefined person formation is detected in response to the number of persons within the threshold distance of the line exceeding a threshold number of persons.

40. The method of claim 36, wherein the scene comprises a sporting event, the persons comprise players in the sporting event, and a first feature vector of the feature vectors comprises a location of a player, a team of the player, a player identification of the player, and a velocity of the player.

41. The method of claim 36, wherein the classifier comprises a graph attention network applied to a plurality of nodes, each comprising one of the feature vectors, and an adjacent matrix that defines connections between the nodes, wherein each of the nodes is representative of one of the persons in the predefined person formation, wherein the method further comprises:
generating the adjacent matrix via evaluation of available pairings of the nodes by applying a connection for a first pairing of first and second nodes where a first distance between first and second persons in the scene represented by the first and second nodes, respectively, does not exceed a threshold and providing no connection for a second pairing of third and fourth nodes where a second distance between third and fourth persons in the scene represented by the third and fourth nodes, respectively, exceeds the threshold.

42. At least one machine readable medium comprising a plurality of instructions that, in response to being executed on a computing device, cause the computing device to identify key persons in immersive video by:
detecting a plurality of persons in a video picture of a first video sequence, the first video sequence comprising one of a plurality of video sequences contemporaneously attained by cameras trained on a scene;
detecting a predefined person formation corresponding to the video picture based on an arrangement of at least some of the persons in the scene;
generating a feature vector for at least each of the persons in the predefined person formation; and
applying a classifier to the feature vectors to indicate one or more key persons from the persons in the predefined person formation.

43. The machine readable medium of claim 42, wherein detecting the predefined person formation comprises:
dividing the plurality of persons into first and second subgroups; and
determining whether the first and second groups of persons overlap spatially with respect to an axis applied to the scene, wherein the predefined person formation is detected in response to no spatial overlap between the first and second groups.

44. The machine readable medium of claim 43, wherein determining whether the first and second groups of persons overlap spatially comprises:
identifying a first person of the first subgroup that is a maximum distance along the axis among the persons of the first subgroup and a second person of the second subgroup that is a minimum distance along the axis among the persons of the second subgroup; and
detecting no spatial overlap between the first and second groups in response to the second person being a greater distance along the axis than the first person.

45. The machine readable medium of claim 43, wherein said detecting the predefined person formation further comprises:
detecting a number of persons from the first and second subgroups that are within a threshold distance of a line dividing the first subgroup and the second subgroup, wherein the line is orthogonal to the axis applied to the scene, and the predefined person formation is detected in response to the number of persons within the threshold distance of the line exceeding a threshold number of persons.

46. (canceled)
